(19) United States
(12) Patent Application Publication
(10) Pub. No.: US 2024/0349267 A1
(43) Pub. Date: Oct. 17, 2024

(54) TRANSMISSIONS WITHOUT CORRESPONDING GRANTS FOR EXTENDED REALITY SERVICE

(71) Applicant: Lenovo (Singapore) Pte. Ltd., New Tech Park (SG)

(72) Inventors: Hossein Bagheri, Urbana, IL (US); Hyejung Jung, Northbrook, IL (US); Ankit Bhamri, Rödermark (DE); Joachim Löhr, Wiesbaden (DE); Karthikeyan Ganesan, Kronberg im Taunus (DE); Alexander Golitschek Edler von Elbwart, Darmstadt (DE); Vijay Nangia, Woodridge, IL (US); Ravi Kuchibhotla, Chicago, IL (US)

(21) Appl. No.: 18/685,156

(22) PCT Filed: Aug. 18, 2022
(86) PCT No.: PCT/IB2022/057778

§ 371 Date: Feb. 20, 2024

Related U.S. Application Data
(60) Provisional application No. 63/234,681, filed on Aug. 18, 2021.

(51) Int. Cl. H04W 72/11; H04L 1/1812; H04W 72/21

(52) U.S. Cl. CPC H04W 72/11; H04L 1/1812; H04W 72/21

(57) ABSTRACT

Apparatuses, methods, and systems are disclosed for transmissions without corresponding grants. One method includes receiving a DL transmission in an SPS resource of a plurality of SPS resources within an SPS period corresponding to an SPS configuration of a plurality of SPS configurations; generating a HARQ feedback corresponding to the received DL transmission; determining an SPS reference corresponding to the DL transmission; and transmitting the HARQ feedback in an UL resource corresponding to the determined SPS reference, where the SPS reference includes a reference SPS configuration of the plurality of SPS configurations, a reference SPS resource (different than the SPS resource). of the plurality of SPS resources, or a combination thereof.

### CROSS-REFERENCE TO RELATED APPLICATIONS

This application claims priority to U.S. Provisional Patent Application No. 63/234,681 entitled “TRANSMISSIONS WITHOUT CORRESPONDING GRANTS FOR EXTENDED REALITY SERVICE” and filed on 18 Aug. 2021 for Hossein Bagheri, Hyejung Jung, Ankit Bhamri, Joachim Löhr, Karthikeyan Ganesan, Alexander Golitschek Edler von Elbwart, Vijay Nangia, and Ravi Kuchibhotla, which application is incorporated herein by reference.

### FIELD

The subject matter disclosed herein relates generally to wireless communications and more particularly relates to schemes for transmissions without corresponding grants for extended reality service.

### BACKGROUND

Extended Reality (“XR”) is an umbrella term for different types of realities including Virtual reality (“VR”), Augmented reality (“AR”), and Mixed reality (“MR”). XR refers to all real-and-virtual combined environments and human-machine interactions generated by computer technology and wearables.

For Semi-Persistent Scheduling (“SPS”), a base station can allocate downlink (“DL”) resources for the initial Hybrid Automatic Repeat Request (“HARQ”) transmissions to User Equipments (“UEs”).

### BRIEF SUMMARY

Disclosed are procedures for transmissions without corresponding grants. Said procedures may be implemented by apparatus, systems, methods, or computer program products.

One method at a User Equipment (“UE”) includes receiving a DL transmission in a semi-persistently scheduled (“SPS”) resource of a plurality of SPS resources within an SPS period corresponding to an SPS configuration of a plurality of SPS configurations and generating a Hybrid Automatic Repeat Request (“HARQ”) feedback corresponding to the received DL transmission. The method includes determining an SPS reference corresponding to the DL transmission, the SPS reference comprising a reference SPS configuration of the plurality of SPS configurations, a reference SPS resource of the plurality of SPS resources, or a combination thereof. The method includes transmitting the HARQ feedback in an uplink (“UL”) resource corresponding to the determined SPS reference, the reference SPS resource being different than the SPS resource.

Another method at a UE includes determining a set of configured grant (“CG”) transmission occasions (“TOs”) from a plurality of CG TOs within a CG period of a CG configuration for transmission of an UL transport block (“TB”). The method includes selecting an UL resource from a plurality of UL resources, wherein the selection is based on the determined set of CG TOs and transmitting, using the selected UL resource, an indication of the determined set of CG TOs to a mobile communication network. The method includes transmitting a respective UL TB on an UL channel in the determined set of CG TOs.

One method at a network device includes determining an SPS resource of a plurality of SPS resources within an SPS period corresponding to an SPS configuration of a plurality of SPS configurations and transmitting a DL transmission in the determined SPS resource. The method includes determining an SPS reference corresponding to the TB, the SPS reference including a reference SPS configuration of the plurality of SPS configurations, a reference SPS resource of the plurality of SPS resources, or a combination thereof. The method includes receiving HARQ feedback corresponding to the DL transmission in an UL resource corresponding to the determined SPS reference, the reference SPS resource being different than the SPS resource.

Another method at a network device includes transmitting a CG configuration to a UE and receiving, from the UE, an indication indicating a first set of CG TOs within a period of a CG configuration. The method includes receiving, from the UE, a first UL transmission on an UL channel during the first set of CG TOs and scheduling a second UL transmission in a second set of CG TOs within the period of the CG configuration, where the first set and the second set of CG TOs are mutually exclusive.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for transmissions without corresponding grants;

FIG. 2 is a diagram illustrating one embodiment of a New Radio (“NR”) protocol stack;

FIG. 3 is a diagram illustrating one embodiment of a set of SPS configurations for transmissions without corresponding grants;

FIG. 4 is a diagram illustrating one embodiment of a set of CG configurations for transmissions without corresponding grants;

FIG. 5 is a diagram illustrating one embodiment of a SPS-Config information element for transmissions without corresponding grants;

FIG. 6 is a diagram illustrating one embodiment of SPS occasion aggregation for transmissions without corresponding grants;

FIG. 7 is a diagram illustrating another embodiment of SPS occasion aggregation for transmissions without corresponding grants;

FIG. 8 is a block diagram illustrating one embodiment of a user equipment apparatus that may be used for transmissions without corresponding grants;

FIG. 9 is a block diagram illustrating one embodiment of a network apparatus that may be used for transmissions without corresponding grants;

FIG. 10 is a flowchart diagram illustrating one embodiment of a first method for DL transmission without corresponding grants;

FIG. 11 is a flowchart diagram illustrating one embodiment of a second method for DL transmission without corresponding grants;

FIG. 12 is a flowchart diagram illustrating one embodiment of a first method for UL transmission without corresponding grants; and

FIG. 13 is a flowchart diagram illustrating one embodiment of a second method for UL transmission without corresponding grants.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having.” and variations thereof mean “including but not limited to,” unless expressly specified otherwise. An enumerated listing of items does not imply that any or all of the items are mutually exclusive, unless expressly specified otherwise. The terms “a.” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for mechanisms for transmissions without corresponding grants. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

A service-oriented design considering XR traffic characteristics (e.g., variable packet arrival rate: packets coming at 30-120 frames/second with some jitter, also packets having variable and large packet size) can enable more efficient (e.g., in terms of satisfying XR service requirements for a greater number of UEs, or in terms of UE power saving) XR service delivery.

VR is a rendered version of a delivered visual and audio scene. The rendering is designed to mimic the visual and audio sensory stimuli of the real world as naturally as possible to an observer or user as they move within the limits defined by the application. Virtual reality usually, but not necessarily, requires a user to wear a head mounted display (“HMD”), to completely replace the user's field of view with a simulated visual component, and to wear headphones, to provide the user with the accompanying audio. Some form of head and motion tracking of the user in VR is usually also necessary to allow the simulated visual and audio components to be updated in order to ensure that, from the user's perspective, items and sound sources remain consistent with the user's movements. Additional means to interact with the virtual reality simulation may be provided but are not strictly necessary.

AR is when a user is provided with additional information or artificially generated items, or content overlaid upon their current environment. Such additional information or content will usually be visual and/or audible and their observation of the user's current environment may be direct (i.e., with no intermediate sensing, processing, and rendering) or indirect (i.e., where the user's perception of their environment is relayed via sensors and may be enhanced or processed). MR is an advanced form of AR where some virtual elements are inserted into the physical scene with the intent to provide the illusion that these elements are part of the real scene.

The solutions described herein disclose embodiments for determining a Semi-Persistent Scheduling (“SPS”) resource from a plurality of SPS resources within an SPS periodicity for receiving only a single Physical Downlink Shared Channel (“PDSCH”) in the plurality of SPS resources. In one embodiment, a communication device determines a reference SPS resource/configuration. In another embodiment, the communication device determines, based on the reference SPS resource/configuration, a HARQ-ACK resource in response to receiving the PDSCH. As used herein, “HARQ-ACK” may represent collectively the Positive Acknowledge (“ACK”) and the Negative Acknowledge (“NACK”). ACK means that a TB is correctly received while NACK means a TB is erroneously received.

To enhance system capacity or UE power consumption, a network device may select a SPS and/or CG resource from a plurality of SPS/CG resources within an SPS/CG periodicity. In some embodiments, a communication device aggregates one or more of SPS/CG occasions of same/different SPS/CG configurations for receiving a single PDSCH/PDSCH transmissions corresponding to a single TB and/or transmitting a single Physical Uplink Shared Channel (“PUSCH”)/PUSCH transmissions corresponding to a single TB.

Regarding SPS, a Fifth Generation (“5G”) base station may allocate DL resources for the initial HARQ transmissions to UEs. Radio Resource Control (“RRC”) defines the periodicity of the configured DL assignments while Physical Downlink Control Channel (“PDCCH”) addressed to Configured Scheduling Radio Network Temporary Identifier (“CS-RNTI”) can either signal and activate the configured DL assignment, or deactivate it, i.e., a PDCCH addressed to CS-RNTI indicates that the DL assignment can be implicitly reused according to the periodicity defined by RRC, until deactivated. When required, retransmissions may be explicitly scheduled via PDCCH(s).

The dynamically allocated DL reception overrides the configured DL assignment in the same serving cell if they overlap in time. Otherwise, a DL reception according to the configured DL assignment is assumed, if activated.

The UE may be configured with up to eight (8) active configured DL assignments for a given bandwidth part (“BWP”) of a serving cell. When more than one DL assignment is configured, the network decides which of these configured DL assignments are active at a time (including all of them). Each configured DL assignment is activated separately using a Downlink Control Information (“DCI”) command (also referred to as “activation DCI”) and deactivation of configured DL assignments is done using a DCI command (also referred to as “deactivation DCI”), which can either deactivate a single configured DL assignment or multiple configured DL assignments jointly.

XR refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).

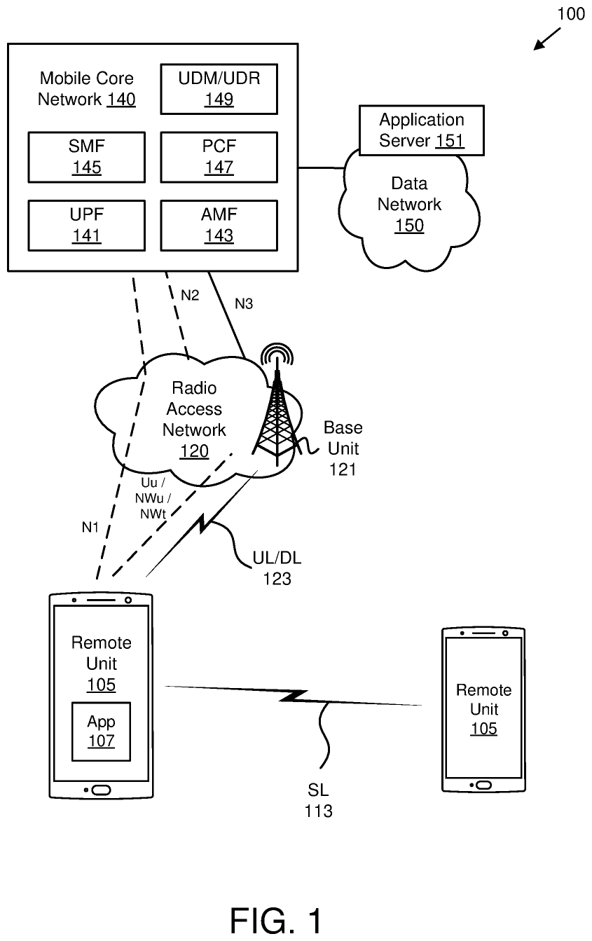

FIG. 1 depicts a wireless communication system 100 for transmissions without corresponding grants, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G cellular system specified in the Third Generation Partnership Project (“3GPP”) specifications. For example, the RAN 120 may be a Next Generation Radio Access Network (“NG-RAN”), implementing NR Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example, the Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via UL and DL communication signals. Furthermore, the UL and DL communication signals may be carried over the wireless communication links 123. Furthermore, the UL communication signals may comprise one or more uplink channels, such as the Physical Uplink Control Channel (“PUCCH”) and/or PUSCH, while the DL communication signals may comprise one or more DL channels, such as the PDCCH and/or PDSCH. Here, the RAN 120 is an intermediate network that provides the remote units 105 with access to the mobile core network 140.

In various embodiments, the remote units 105 may communicate directly with each other (e.g., device-to-device communication) using sidelink communication 113. Here, sidelink transmissions may occur on sidelink resources. A remote unit 105 may be provided with different sidelink communication resources according to different allocation modes. As used herein, a “resource pool” refers to a set of resources assigned for sidelink operation. A resource pool consists of a set of resource blocks (i.e., Physical Resource Blocks (“PRB”)) over one or more time units (e.g., subframe, slots, Orthogonal Frequency Division Multiplexing (“OFDM”) symbols). In some embodiments, the set of resource blocks comprises contiguous PRBs in the frequency domain. A PRB, as used herein, consists of twelve consecutive subcarriers in the frequency domain.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or Packet Data Network (“PDN”) connection) with the mobile core network 140 via the RAN 120. The PDU session represents a logical connection between the remote unit 105 and the User Plane Function (“UPF”) 141. The mobile core network 140 then relays traffic between the remote unit 105 and the application server 151 in the packet data network 150 using the PDU session (or other data connection).

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5Q1”).

In the context of a 4G/LTE system, such as the Evolved Packet System (“EPS”), a PDN connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Spectrum (“NAS”) signaling. NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for transmissions without corresponding grants apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-eNB, eNB, Base Station (“BS”), Access Point (“AP”), NR BS, 5G NB, Transmission and Reception Point (“TRP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for transmissions without corresponding grants.

In the following, instead of “slot,” the terms “mini-slot,” “subslot,” or “aggregated slots” can also be used, wherein the notion of slot/mini-slot/sub-slot/aggregated slots can be described as defined in 3GPP Technical Specification (“TS”) 38.211, TS 38.213, and/or TS 38.214. Throughout this disclosure reference to TS 38.211, TS 38.212, TS 38.213, TS 38.214 is associated with version 16.4.0 of the 3GPP specifications.

Several solutions to provide variable resource timing and size are described below. According to a possible embodiment, one or more elements or features from one or more of the described solutions may be combined.

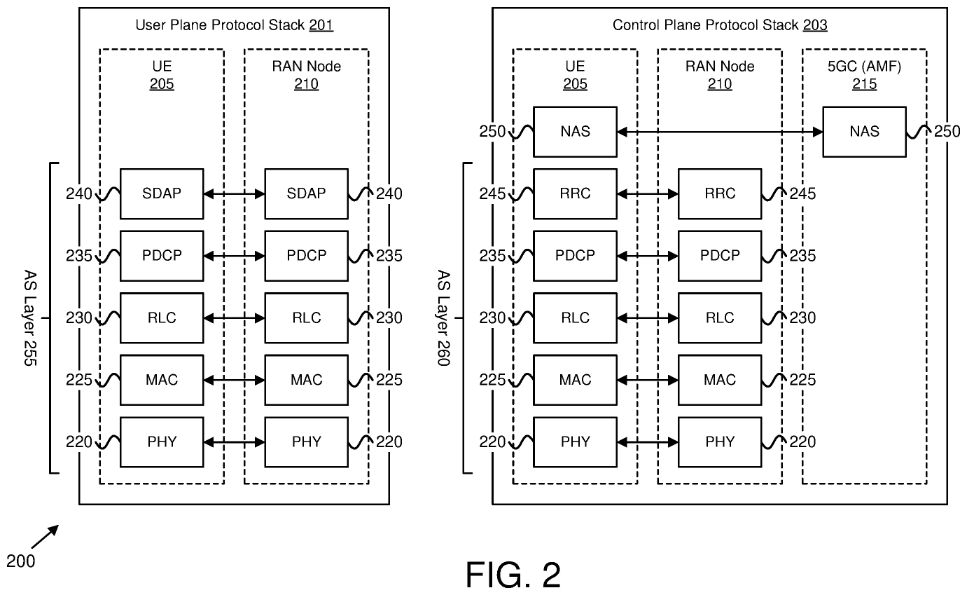

FIG. 2 depicts a NR protocol stack 200, according to embodiments of the disclosure. While FIG. 2 shows the UE 205, the RAN node 210 and an AMF 215 in a 5G core network (“5GC”), these are representative of a set of remote units 105 interacting with a base unit 121 and a mobile core network 140. As depicted, the NR protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) layer 240. The Control Plane protocol stack 203 includes a PHY layer 220, a MAC sublayer 225, a RLC sublayer 230, and a PDCP sublayer 235. The Control Plane protocol stack 203 also includes a Radio Resource Control (“RRC”) layer 245 and a Non-Access Stratum (“NAS”) layer 250.

The AS layer 255 (also referred to as “AS protocol stack”) for the User Plane protocol stack 201 consists of at least SDAP, PDCP, RLC and MAC sublayers, and the physical layer. The AS layer 260 for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC layer 245 and the NAS layer 250 for the control plane and includes, e.g., an IP layer and/or PDU Layer (not depicted) for the user plane. L1 and L2 are referred to as “lower layers,” while L3 and above (e.g., transport layer, application layer) are referred to as “higher layers” or “upper layers.”

The PHY layer 220 offers transport channels to the MAC sublayer 225. The PHY layer 220 may perform a beam failure detection procedure using energy detection thresholds, as described herein. In certain embodiments, the PHY layer 220 may send an indication of beam failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and an AMF 215 in the 5GC. NAS messages are passed transparently through the RAN. The NAS layer 250 is used to manage the establishment of communication sessions and for maintaining continuous communications with the UE 205 as it moves between different cells of the RAN. In contrast, the AS layers 255 and 260 are between the UE 205 and the RAN (i.e., RAN node 210) and carry information over the wireless portion of the network. While not depicted in FIG. 2, the IP layer exists above the NAS layer 250, a transport layer exists above the IP layer, and an application layer exists above the transport layer.

The MAC sublayer 225 is the lowest sublayer in the L2 architecture of the NR protocol stack. Its connection to the PHY layer 220 below is through transport channels, and the connection to the RLC sublayer 230 above is through logical channels. The MAC sublayer 225 therefore performs multiplexing and demultiplexing between logical channels and transport channels: the MAC sublayer 225 in the transmitting side constructs MAC PDUs (also known as TBs) from MAC Service Data Units (“SDUs”) received through logical channels, and the MAC sublayer 225 in the receiving side recovers MAC SDUs from MAC PDUs received through transport channels.

The MAC sublayer 225 provides a data transfer service for the RLC sublayer 230 through logical channels, which are either control logical channels which carry control data (e.g., RRC signaling) or traffic logical channels which carry user plane data. On the other hand, the data from the MAC sublayer 225 is exchanged with the PHY layer 220 through transport channels, which are classified as UL or DL. Data is multiplexed into transport channels depending on how it is transmitted over the air.

The PHY layer 220 is responsible for the actual transmission of data and control information via the air interface, i.e., the PHY Layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the modulation and coding scheme (“MCS”)), the number of physical resource blocks, etc.

According to embodiments of a first solution, a UE 205 may be configured with a set of SPS configurations (e.g., for a BWP). In some embodiments, the UE 205 determines a first subset of SPS configurations of the set of SPS configurations. In one implementation, the UE 205 determines the first subset of SPS configurations based on an indication (e.g., configuration) from a network entity (e.g., the RAN node 210).

In certain embodiments, the first subset may be determined based on other (i.e., at least one) transmission parameters, e.g., configuration parameters such as a parameter that is associated with/indicates one or more of a traffic periodicity (e.g., a frame-per-second (“FPS”) target associated with a video traffic), a traffic arrival time jitter/variation, a packet delay bound/budget, a traffic data rate, and/or priority level.

In some embodiments, the first subset of SPS configurations is activated and released jointly together. In an example, the first subset of SPS configurations is configured by RRC. The number of SPS configurations which can be jointly activated is determined, e.g., based on the RRC configuration.

In some embodiments, a reference SPS configuration may be determined, where the resource for each SPS configuration is determined based on the resource indicated in the activation DCI for the reference SPS configuration. In one implementation, the RAN node 210 determines the reference SPS configuration and may indicate the reference SPS configuration to the UE 205, e.g., by RRC. In another embodiment, the reference SPS configuration may be specified in 3GPP specifications.

In an example, the reference SPS configuration is the SPS configuration with the lowest SPS configuration index amongst the first subset of SPS configurations. In another example, the reference SPS configuration can be determined based on other (i.e., at least one) transmission parameters, e.g., configuration parameters such as a parameter that is associated with/indicates a traffic periodicity (e.g., an FPS target associated with a video traffic), a traffic arrival time jitter/variation, packet delay bound, traffic data rate, and/or priority level. In one embodiment, parameters of resource determination for SPS configurations of the first subset of SPS configurations from the resources indicated in the activation DCI for the reference SPS configuration (e.g., such as resource offset, hopping, scaling) can be configured for each SPS configuration.

In certain embodiments, the maximum number of SPS configurations within the first subset of SPS configurations of the set of SPS configurations is reported by UE capability signaling. In other embodiments, the maximum number of SPS configurations within the first subset of SPS configurations of the set of SPS configurations is fixed in 3GPP specifications.

In certain embodiments, the UE 205 provides one HARQ-ACK (e.g., only one HARQ-ACK bit) corresponding to the first subset of SPS configurations. In one embodiment, the UE 205 receives/decodes (e.g., is expected to decode) only one PDSCH from the first subset of SPS configurations. In another embodiment, the UE 205 provides HARQ-ACK (e.g., one HARQ-ACK bit) corresponding to a reference SPS configuration (e.g., the SPS configuration whose SPS occasion ends the latest amongst the SPS occasions of the first subset of SPS configurations in one period). Alternatively, the reference SPS configuration may be indicated to the UE 205 (e.g., by RRC, MAC Control Element (“CE”), or a DCI-such as activation DCI-which jointly activates the first subset of SPS configurations).

In various embodiments, most of the SPS configuration parameters are the same amongst the SPS configurations of the first subset of SPS configurations. Therefore, the UE 205 may be configured with a HARQ-ACK codebook index indicating a HARQ-ACK priority for the first subset of SPS configurations.

In one example, one or more of the following parameters are the same amongst the first subset of SPS configurations: periodicity, mcs-Table, nrofHARQ-Processes, harq-ProcID-Offset, harq-CodebookID, and/or pdsch-AggregationFactor.

In other embodiments, only SPS configuration index is different amongst the first subset of SPS configurations. In an example, the UE 205 is configured with a ‘super’ SPS configuration (or SPS configuration group) with a ‘super’ SPS configuration index (or SPS configuration group index), and the ‘super’ SPS configuration comprises multiple SPS configuration indices. In another example, if the UE 205 is configured with a ‘super’SPS configuration with a ‘super’ SPS configuration index, then the ‘super’ SPS configuration can comprise: A) Single/common frequency domain resource allocation applicable to all the SPS configuration indices contained within the ‘super’ SPS configuration, B) Single Quasi-Co-Location (“QCL”) assumption associated with all the SPS configurations within the ‘super’ SPS configuration or C) Single time-domain resource allocation indicating the starting point associated with the first SPS configuration within the ‘super’ SPS configuration, duration for the first SPS configuration and additionally offsets (e.g., offset-list) for the duration (relative to first SPS configuration) associated with the SPS configurations (e.g., each SPS configurations other than the first SPS configuration) within the ‘super’ SPS configuration.

In some implementations, a reference SPS configuration may be used instead of the first SPS configuration in the above ‘super’ SPS configuration(s). Note that two antenna ports are said to be quasi-co-located if properties of the channel over which a symbol on one antenna port is conveyed can be inferred from the channel over which a symbol on the other antenna port is conveyed.

In some embodiments, the ‘super’ SPS configuration may comprise a single time-domain resource allocation indicating the starting point associated with the first SPS configuration within the ‘super’ SPS configuration, a duration for the first SPS configuration and—additionally—offsets (e.g., offset-list) for the starting point (relative to the first SPS configuration) associated with the SPS configurations (e.g., each SPS configurations other than the first SPS configuration) within the ‘super’ SPS configuration.

Where only SPS configuration index is different amongst the first subset of SPS configurations, the activation DCI indicates the ‘super’ SPS configuration index. In certain embodiments, a HARQ process number is defined for ‘super’ SPS configuration, e.g., all the SPS configurations/resources within the ‘super’ SPS configuration are using the same determined HARQ process identifier (“ID”).

In one embodiment, the HARQ process ID associated with the slot where the DL transmission starts is derived from the following equation, wherein the parameter CURRENT_slot refers to a current (or first) slot (or similar time unit) of a ‘reference’ SPS configuration in an SPS occasion

$$HARQ process ID = [ floor ( CURRENT\_slot \times 10 / ( numberOfSlotsPerFrame \times periodicity ) ) ] modulo nrofHARQ - Processes + harq - ProcID - Offset$$

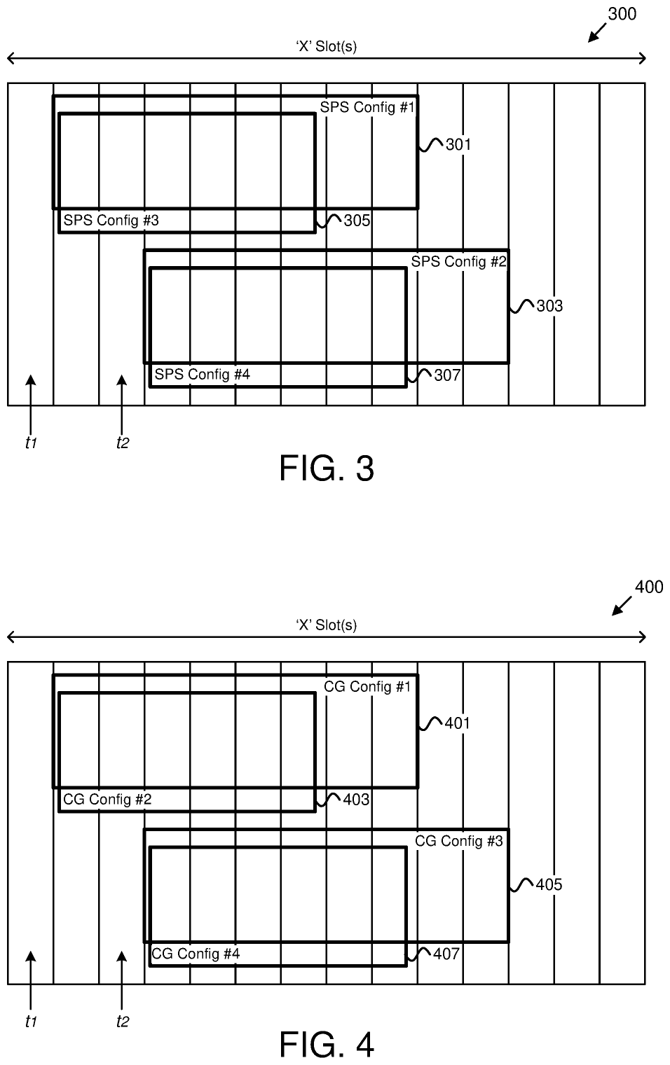

FIG. 3 depicts a schema 300 for a set of SPS configurations over ‘X’ slot(s), according to embodiments of the disclosure. The set of SPS configurations includes a first SPS configuration (depicted as “SPS Config #1”) 301, a second SPS configuration (depicted as “SPS Config #2”) 303, a third SPS configuration (depicted as “SPS Config #3”) 305, and a fourth SPS configuration (depicted as “SPS Config #4”) 307. The set of SPS configurations 301, 303, 305, and 307 are candidates for a single PDSCH transmission over ‘X’ slot(s).

If a data packet (e.g., for XR traffic) comes at time t1 with size close to P1, then the RAN node 210 (e.g., gNB) uses a SPS occasion of the first SPS configuration 301 to transmit the data packet to the UE 205. If a data packet comes at time t1 with size close to P2 (where P2<P1), then the RAN node 210 uses a SPS occasion of the third SPS configuration 305 to transmit the data packet to the UE 205.

If a data packet comes at time t2 with size close to P1, then the RAN node 210 uses a SPS occasion of the second SPS configuration 303 to transmit the data packet to the UE 205. If a data packet comes at time t2 with size close to P2>P1, then the RAN node 210 uses a SPS occasion of the fourth SPS configuration 307 to transmit the data packet to the UE 205.

In some embodiments, a set of SPS configurations of the first subset of SPS configurations has SPS occasions starting/ending at the same time in an SPS period. For example, FIG. 3 depicts where SPS occasions of the first SPS configuration 301 and the third SPS configuration 305 start at the same time, similarly for SPS occasions of the second SPS configuration 303 and fourth SPS configuration 307.

In some embodiments, using multiple SPS configurations with same start time or end time of SPS resources (or SPS occasions) allows for reduced UE decoding complexity, e.g., in terms of performing blind decoding for which SPS configuration is used for a PDSCH transmission and buffering for potential PDSCH. In further embodiments, the UE 205 may further support one or more of the following additional indications to reduce decoding complexity:

In certain embodiments, the additional indication includes a Demodulation Reference Signal (“DMRS”) (e.g., front-load DMRS). The additional indication may be used to indicate whether an SPS resource corresponding to a first SPS configuration (e.g., the first SPS configuration 301 in FIG. 3) or an SPS resource corresponding to a second SPS configuration (e.g., the third SPS configuration 305 in FIG. 3) is used for PDSCH. In certain embodiments, the frequency resources for the first SPS configuration and second SPS configuration are the same, but the time resource for the first SPS configuration may be longer than (and contain) the time resource for the second SPS configuration.

In an example, the first SPS configuration has a first DL DMRS scrambling initialization (or DMRS scrambling ID), and the second SPS configuration has a second DL DMRS scrambling initialization (or DMRS scrambling ID).

In another example, the DL DMRS scrambling initialization is determined based on a parameter dependent on: the symbol/time unit where an SPS occasion of a SPS configuration ends; or the time duration (e.g., in number of symbols) of an SPS occasion of a SPS configuration.

In a further example, the DL DMRS may be located in a symbol (or similar time unit) that is common or overlapping (e.g., first common/overlapping symbol) to at least a subset of the set of SPS configurations. For example, with reference to FIG. 3, the DL DMRS may be located on the first symbol of slot 3, which corresponds to the first symbol of the second SPS configuration 303 and fourth SPS configuration 307, and which symbol is common to all four SPS configurations (i.e., first SPS configuration 301, second SPS configuration 303, third SPS configuration 305, and fourth SPS configuration 307). Moreover, the DMRS sequence for the DL DMRS (e.g., with different DMRS scrambling initialization and/or DMRS scrambling ID) can indicate the SPS configuration index of the SPS resource used for PDSCH.

In certain embodiments, the additional indication includes a MAC Control Element (“CE”) indication, e.g., separately coded within the PDSCH. In one embodiment, the MAC CE may be located at the beginning of the PDSCH.

In certain embodiments, the additional indication includes data-associated control information in some resources of PDSCH (e.g., a predetermined starting position, a number of Resource Elements (“REs”) based on the minimum communication range (“MCR”), and/or a scaling (beta) factor, separately coded from the PDSCH) can indicate the SPS configuration. In one example, the data-associated control information may be located in a symbol/time unit that is common or overlapping (e.g., first common/overlapping symbol) to at least a subset of the set of SPS configurations. For example, with reference to FIG. 3, the data-associated control information may be located on the first symbol of slot, which corresponds to the first symbol of the second SPS configuration 303 and fourth SPS configuration 307, and which symbol is common to all four SPS configurations (i.e., first SPS configuration 301, second SPS configuration 303, third SPS configuration 305, and fourth SPS configuration 307). In some examples, a common reference signal (“RS”) (e.g., same scrambling initialization/ID) may be included in the common symbol or in a portion of the data-associated control REs to aid in receiving/decoding the data-associated control information and identifying the SPS configuration index.

In certain embodiments, the additional indication includes a SPS-ConfigIndicator, e.g., MAC CE or data-associated control information which is transmitted on separate SPS and/or PDSCH resources, which is indicating whether the data transmission for an SPS period occurs, e.g., on the first set of SPS configurations (e.g., the first SPS configuration 301 and third SPS configuration 305 in FIG. 3) or the second set of SPS configurations (e.g., second SPS configuration 303 and fourth SPS configuration 307 in FIG. 3). In one example, the SPS-ConfigIndicator may be transmitted on SPS resources of a SPS configuration prior to the start of the earliest SPS configuration (e.g., first SPS configuration 301 and third SPS configuration 305 in FIG. 3). In one example, the SPS-ConfigIndicator points to the (set of) SPS configuration used by the RAN node 210 for PDSCH transmission in a given SPS period.

In some embodiments, the first subset of SPS configurations spans ‘X’ time units/slots, where ‘X’ is not larger than the SPS periodicity of the first subset of SPS configurations.

In some embodiments, the RAN node 210 may configure SPS parameters according to traffic jitter distribution and packet size distribution. In certain embodiments, the number of different starting symbols/time units and relative start for the first subset of SPS configurations (compared to each other, e.g., between SPS configurations in the first subset of SPS configurations) can be determined based on the jitter distribution, and relative resource size of first subset of SPS configurations can be determined based on the packet size distribution.

In some embodiments, a Δ_{MCS} can be reported (e.g., by the UE 205 to the RAN node 210) associated to the PDSCH, wherein the Δ_{MCS} provides an MCS index or MCS index offset (with respect to the MCS used for PDSCH) transmission for which a target Block Error Rate (“BLER”, i.e., a ratio of the number of erroneous blocks to the total number of blocks transmitted) is expected to be achieved for the PDSCH. The target BLER can be configured for the reference SPS configuration, can be configured for the first SPS configuration, can be configured for each SPS configuration of the first subset of SPS configurations, can be determined based on the reference SPS configuration or first SPS configuration. In one example, Δ_{MCS} is calculated from the difference between I_{MCS_tgt} and I_{MCS}, where I_{MCS_tgt} is the largest MCS index such that the estimated BLER for a TB received with this MCS index would be smaller than or equal to a BLER target, and I_{MCS} is the MCS index of the received TB.

According to embodiments of a second solution, aspects of the first solution may be applied to UL CG transmissions. Specifically, the UE 205 may be configured with a set of CG configurations (e.g., for a BWP), and the UE 205 determines a first subset of CG configurations of the set of CG configurations based on an indication from the network (e.g., RAN node 210) and/or based on other transmission parameters. Moreover, multiple CG configuration parameters may be the same amongst the CG configurations of each subset of CG configurations. Accordingly, the UE 205 may be configured with a ‘super’ CG configuration (or CG configuration group) with a ‘super’ CG configuration index (or CG configuration group index), where the ‘super’ CG configuration comprises multiple CG configuration indices. Some additional embodiments and examples applicable to CG configurations are provided in the following:

In some embodiments, the UE 205 may be configured with multiple CG configurations and picks one CG configuration for transmission of a TB (e.g., based on packet/TB size and arrival). The UE is not expected/allowed to transmit more than one Configured Grant Physical Uplink Shared Channel (“CG-PUSCH”) in a first subset of active CG-PUSCH configurations.

In some embodiments, the UE 205 may indicate which CG resource/configuration is used for transmission of a TB in the first subset of active CG-PUSCH configurations. In an example, Configured Grant Uplink Control Information (“CG-UCI”) is used for such indication.

In another example, the indicator could be signaled by means of a Scheduling Request (“SR”) on PUCCH, i.e., there is an association between the SR configuration and a CG configuration/set of CG configurations. This would allow the RAN node 210 to re-allocate the “unused” CG resources to other UEs. It is noted that such approach would work when latency target/requirement allows to send such CG configuration indicator.

FIG. 4 depicts a schema 400 for a set of CG configurations over ‘X’ slot(s), according to embodiments of the disclosure. The set of CG configurations includes a first CG configuration (depicted as “CG Config #1”) 401, a second CG configuration (depicted as “CG Config #2”) 403, a third CG configuration (depicted as “CG Config #3”) 405, and a fourth CG configuration (depicted as “CG Config #4”) 407. The set of CG configurations 401, 403, 405, and 407 are candidates for a single PDSCH transmission over ‘X’ slot(s).

In various embodiments, an indication in a PUCCH resource indicates if any TB transmission occurs in the first, second, third, and fourth CG configurations (i.e., CG configurations 401, 403, 405, and 407) within ‘X’ slots/time units. In an example, as shown in FIG. 4, a first PUCCH resource (e.g., SR #1) may indicate whether any TB transmission occurs in first, second, third, and fourth CG configuration (at most one of the CG configurations will be used for PUSCH transmission in ‘X’ slots/time units). In some embodiments, the first PUCCH resource occurs prior to the end of the earliest ending CG configuration (the second CG configuration 403 in FIG. 4).

Upon decoding the transmission on the first PUCCH resource, the RAN node 210 may use some remaining part of unused CG configurations. For example, if the UE 205 had used the second CG configuration 403 (e.g., for transmitting PUSCH and indicated in the first PUCCH resource), then CG resources after the end of the second CG configuration 403 can be reused for scheduling UL transmissions.

In other embodiments, a first PUCCH resource (e.g., SR #1) is used to indicate whether any TB transmission occurs in the first CG configuration 401 or the second CG configuration 403 (e.g., as depicted in FIG. 4), and a second PUCCH resource (e.g., SR #2) is used to indicate whether any TB transmission occurs in the third CG configuration 405 or the fourth CG configuration 407 (e.g., as depicted in FIG. 4). One benefit of this approach is to consider transmission timelines. For instance, if a TB occurs at time t2, then the first PUCCH resource may be unable to indicate such TB occurrence. On the other hand, if a TB arrives at time 11, using the second PUCCH resource to indicate that the first CG configuration 401 or the second CG configuration 403 is being used to convey the TB might not be that useful as the RAN node 210 needs to at least start filling the PUSCH buffer for the beginning part of the first CG configuration 401 and the second CG configuration 403.

In one implementation, the first PUCCH resource (e.g., SR #1)—or the starting or ending symbol of the PUCCH resource—occurs not later (in time) than the start of the first CG configuration 401 or the second CG configuration 403 (e.g., to leave some PUCCH/SR processing time), and the second PUCCH resource (e.g., SR #2) occurs no later (in time) than the start of the third CG configuration 405 or the fourth CG configuration 407.

In an example, the UE 205 is configured/indicated traffic arrival and traffic size related parameters, and the UE 205 chooses the CG resource/configuration based on the arrived traffic and configured/indicated traffic arrival and traffic size related parameters. In an example, similar to the scenario described with reference to FIG. 3 (where instead of SPS configurations, there are CG configurations), the UE 205 is indicated P1, P2, t1, t2, etc., and the UE 205 chooses the CG from the set of CGs based on the arrived traffic and P1, P2, t1, t2, etc.

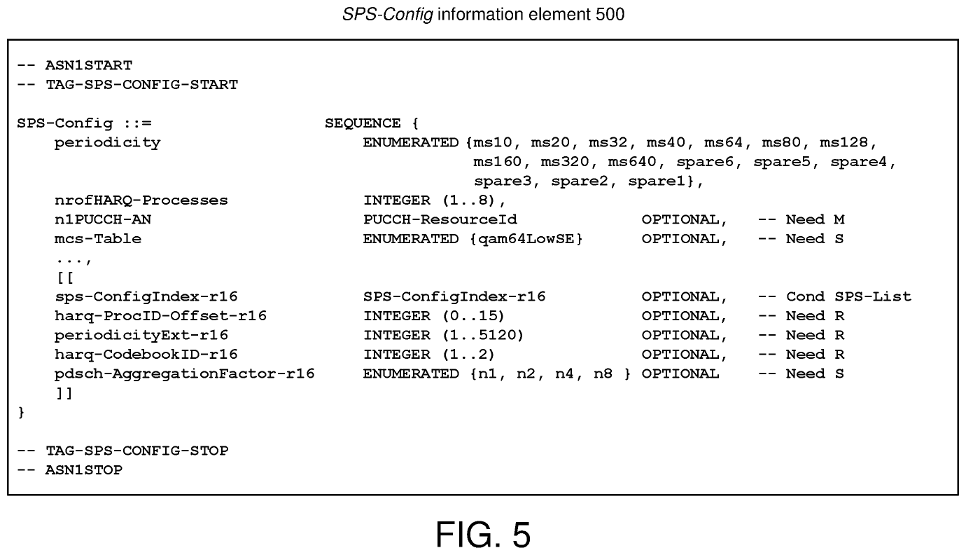

FIG. 5 depicts one embodiment of a SPS-Config information element 500 which may be used to configure a DL semi-persistent transmission. Multiple DL SPS configurations may be configured in one BWP of a serving cell. Table 1 provides field description for the SPS-Config information element 500.

TABLE 1
SPS-Config field descriptions

harq-CodebookID
Indicates the HARQ-ACK codebook index for the corresponding HARQ-ACK codebook for SPS
PDSCH and ACK for SPS PDSCH release.
harq-ProcID-Offset
Indicates the offset used in deriving the HARQ process IDs (e.g., see 3GPP TS 38.321, clause 5.3.1).
mcs-Table
Indicates the MCS table the UE 205 shall use for DL SPS (see 3GPP TS 38.214, clause 5.1.3.1). If
present, the UE 205 shall use the MCS table of low spectral efficiency (“low-SE”) 64QAM table
indicated in Table 5.1.3.1-3 of 3GPP TS 38.214. If this field is absent and field mcs-table in PDSCH-
Config is set to ‘qam256’ and the activation DCI is of format 1_1, then the UE 205 applies the
256QAM table indicated in Table 5.1.3.1-2 of 3GPP TS 38.214. Otherwise, the UE 205 applies the
non-low-SE 64QAM table indicated in Table 5.1.3.1-1 of 3GPP TS 38.214.
n1PUCCH-AN
HARQ resource for PUCCH for DL SPS. The network (e.g., RAN node 210) configures the resource
either as format0 or format1. The actual PUCCH-Resource is configured in PUCCH-Config and
referred to by its ID (e.g., see 3GPP TS 38.213, clause 9.2.3).
nrofHARQ-Processes
Number of configured HARQ processes for SPS DL (e.g., see 3GPP TS 38.321, clause 5.8.1).
pdsch-AggregationFactor
Number of repetitions for SPS PDSCH (e.g., see 3GPP TS 38.214, clause 5.1.2.1). When the field is
absent, the UE 205 applies PDSCH aggregation factor of PDSCH-Config.
periodicity
Periodicity for DL SPS (e.g., see 3GPP TS 38.214 and 3GPP TS 38.321, clause 5.8.1).
periodicityExt
This field is used to calculate the periodicity for DL SPS (see 3GPP TS 38.214 and see 3GPP TS
38.321, clause 5,8.1). If this field is present, the field periodicity is ignored.
The following periodicities are supported depending on the configured subcarrier spacing (in ms):
15 kHz: periodicityExt, where periodicityExt has a value between 1 and 640.
30 kHz: 0.5 × periodicityExt, where periodicityExt has a value between 1 and 1280.
60 kHz w/normal CP: 0.25 × periodicityExt, where periodicityExt has a value between 1 and 2560.
60 kHz w/extended CP: 0.25 × periodicityExt, where periodicityExt has a value between 1 and 2560.
120 kHz: 0.125 × periodicityExt, where periodicityExt has a value between 1 and 5120.
sps-ConfigIndex
Indicates the index of one of multiple SPS configurations.

According to embodiments of a third solution, multiple SPS occasions (or CG occasions) may be aggregated. In an embodiment, a UE 205 may be configured with a set of SPS configurations (e.g., for a BWP).

Here, the UE 205 receives a first PDSCH containing a first part of a TB in a first SPS occasion of a first SPS configuration, initializing a set of aggregated PDSCH transmissions by adding the first PDSCH to the set. The UE 205 determines if there is a second PDSCH containing a second part of the TB in a second SPS occasion of a second SPS configuration. If yes, then the UE 205 receives the second PDSCH transmission, including the second PDSCH to the set of aggregated PDSCH transmissions. The UE 205 further decodes the set of aggregated 10 PDSCH transmissions.

One benefit of such an approach compared to the ‘Super SPS configuration’ approach could be no/less blind decoding of PDSCH is needed. The UE 205 anyways checks if there is PDSCH in every SPS occasion. An additional step compared to existing SPS decoding procedure can be to determine if the TB in a first SPS occasion of a first SPS configuration spans more than the first SPS occasion (e.g., to a second SPS occasion of the first or the second SPS configuration). In an example, there could be ‘W’ PDSCHs associated with ‘W’ SPS occasions of potentially ‘W’ SPS configurations in the set of aggregated PDSCHs. In an example, ‘W’ is reported by UE 205 (e.g., via UE capability reporting/signaling).

In an embodiment, the UE 205 determines if there is a second PDSCH containing a second part of the TB in a second SPS occasion of a second SPS configuration based on an indication in the first SPS occasion of the first SPS configuration.

In one implementation, the indication is a marker signal sent in the first SPS occasion. In an example, the marker signal occupies a set of REs. The first PDSCH is rate matched around the set of REs. In one example, the marker signal may be a data-associated control information comprising the indicator.

In another implementation, the (e.g., front loaded) DMRS indicates the indication. In an example, the UE 205 based on DMRS (e.g., DMRS Cyclic Shift) determines if the TB transmission continues to another transmission occasion.

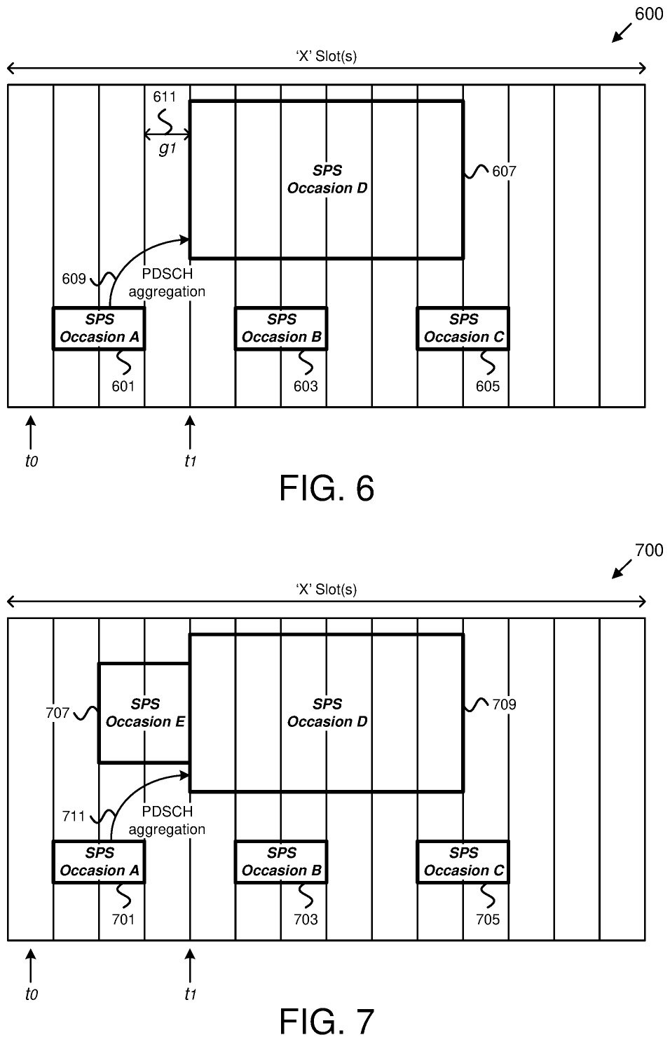

FIG. 6 depicts an exemplary scenario 600 for SPS occasion aggregation, according to embodiments of the disclosure. In the depicted scenario 600, the UE 205 is configured with a first SPS configuration associated with SPS occasion A 601, SPS occasion B 603, and SPS occasion C 605. Additionally, the UE 205 is configured with a second SPS configuration associated with SPS occasion D 607. Here, it is assumed that a packet comes at time t0 (e.g., due to jitter) instead of beginning of SPS occasion D 607 (i.e., which starts time t1). For efficient delivery (i.e., minimized delay) the UE 205 uses SPS occasion A 601 to begin receiving a DL TB corresponding to the early packet. Further, the RAN node 210 indicates in SPS occasion A 601 that the TB transmission continues to SPS occasion D 607 (see PDSCH aggregation indication 609).

In one embodiment, the gap 611 between the end of the first SPS occasion (i.e., the end of SPS occasion A) and the beginning of the second SPS occasion (i.e., the beginning of SPS occasion D 607 of is at least ‘g1’ time units, and no more than ‘g2’ time units. Here, it is assumed that the UE 205 needs some time (which is not larger than ‘g1’ time units) to process the indication, and resumes aggregating the PDSCH transmissions in response to determining there is a second PDSCH transmission containing a second part of the TB in the second SPS occasion of the second SPS configuration. In an example, g1=‘0’ when front-loaded DMRS is used as the indicator.

In an embodiment, the UE 205 determines if there is a second PDSCH transmission containing a second part of the TB in a second SPS occasion of a second SPS configuration only when the first SPS occasion and second SPS occasion are back-to-back (e.g., no gap or limited gap between the two SPS occasions).

In another embodiment, the same set of transmission parameters (such as MCS) are used across SPS transmission occasions of the TB. In an example, the UE 205 determines if there is a second PDSCH containing a second part of the TB in a second SPS occasion of a second SPS configuration if the same set of transmission parameters (such as MCS) used for SPS occasions of the first SPS configuration and second SPS configuration.

In an embodiment, the UE 205 sends HARQ-ACK in response to the aggregated PDSCH based on a reference SPS occasion (e.g., last SPS occasion of a TB). In one example, a PUCCH resource is configured to report plurality of HARQ-ACK corresponding to plurality of the PDSCH transmissions corresponding to plurality of the SPS configurations. An association of the plurality of SPS configurations to the PUCCH resource could be semi-statically configured.

In another example, the HARQ-ACK resource within a PUCCH resource may be determined based on the lowest SPS configuration index to the highest SPS configuration index. Aggregation of the HARQ-ACK for an SPS occasion for each SPS configuration may be possible when latency allows and for such case, the HARQ-ACK resource is determined first based on the SPS configuration index and then based on the occasions in the corresponding SPS configuration and finally to the next highest SPS configuration index and corresponding occasion and so on.

FIG. 7 depicts an exemplary scenario 700 for SPS occasion aggregation. In the depicted scenario 700, the UE 205 is configured with a first SPS configuration associated with SPS occasion A 701, SPS occasion B 703, and SPS occasion C 705. Additionally, the UE 205 is configured with a second SPS configuration associated with SPS occasion E 707, and a third SPS configuration associated with SPS occasion D 709.

In an embodiment, the UE 205 resolves overlapping SPS occasions (e.g., SPS occasion E 707 and SPS occasion A 701 as shown in FIG. 7) assuming a reference SPS configuration for an aggregated PDSCH (e.g., the first SPS configuration associated with SPS occasion A 701). In an example, the UE 205 is configured with parameters for PDSCH aggregation 711, including a reference SPS configuration index used to resolve any overlapping SPS occasions (e.g., SPS occasion E 707 and SPS occasion A 701) based on a reference SPS configuration index (the first SPS configuration as reference for SPS occasion A 701, instead of the third SPS configuration for SPS occasion A 701). Note that in the depicted embodiment, SPS occasion A 701 is generated/determined based on the first SPS configuration.

In an embodiment, when a TB is transmitted in multiple parts across multiple SPS occasions, then a different Redundancy Version (“RV”) can be applied to each of the TB part corresponding to each of the SPS occasion.

In an embodiment, when multiple SPS occasions need to be aggregated and if the latest SPS occasion of the multiple occasions is only partially used, then the remaining part of that SPS occasion can be utilized for transmission of another PDSCH, wherein whether this another PDSCH has been transmitted to the UE 205 can be determined based on the front-loaded DMRS.

In one example, this can be considered as splitting of one SPS occasion into two separate SPS occasions, where the parameters of the first SPS occasion of the two separate SPS occasions can be based on the previous SPS occasion (for previous PDSCH), and the parameters of the second SPS occasion of the two separate SPS occasions are based on the parameters included in the SPS configuration. In one example, the UE 205 expects to receive another PDSCH on the partial remaining SPS resource only if the number of available symbols (time units) are above a certain threshold. Otherwise, if the number of available symbols is below the threshold, then no additional PDSCH should be expected.

In one embodiment, for UL CG, aggregation of multiple CG resources is applied, and the UE 205 indicates in the CG-UCI about aggregation of multiple CG resources. In one example, if the last CG resource among the aggregated resources is only partially used, then the UE 205 can also indicate the partial availability of that CG resource in the CG-UCI. In another example, the UE 205 indicates if the remaining part of the CG resource is being/has been used for another UL transmission.

According to embodiments of a fourth solution, a plurality of CG resources could be defined in a CG period where the time offset between the CG resources in the period could be different and/or each CG resource size could be differently configured. When a packet arrives in the buffer, the UE 205 selects one CG resource among the plurality of the CG resources within the CG period for transmitting the TB. In one example, the UE 205 can transmit in only one of the CG resources in the period and same HARQ process number is configured to be used for transmission(s) within the CG period. A PUCCH resource is semi-statically configured for reporting one HARQ-ACK bit per CG period.

In an alternative implementation, the UE 205 could be allowed to transmit using the plurality of the CG resources in a period by aggregating the PUSCH transmissions to the multiple CG resources in a period.

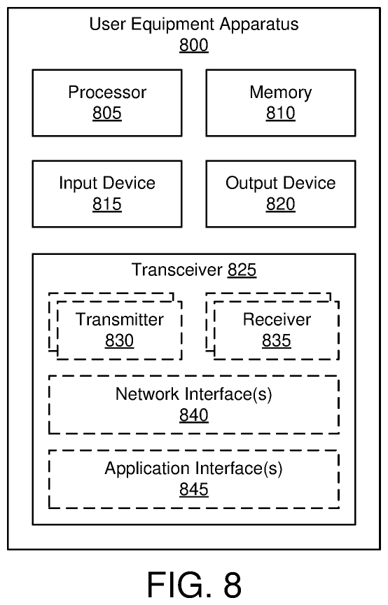

FIG. 8 depicts a user equipment apparatus 800 that may be used for transmissions without corresponding grants, according to embodiments of the disclosure. In various embodiments, the user equipment apparatus 800 is used to implement one or more of the solutions described above. The user equipment apparatus 800 may be one embodiment of a UE endpoint, such as the remote unit 105 and/or the UE 205, as described above. Furthermore, the user equipment apparatus 800 may include a processor 805, a memory 810, an input device 815, an output device 820, and a transceiver 825.

In some embodiments, the input device 815 and the output device 820 are combined into a single device, such as a touchscreen. In certain embodiments, the user equipment apparatus 800 may not include any input device 815 and/or output device 820. In various embodiments, the user equipment apparatus 800 may include one or more of: the processor 805, the memory 810, and the transceiver 825, and may not include the input device 815 and/or the output device 820.

As depicted, the transceiver 825 includes at least one transmitter 830 and at least one receiver 835. In some embodiments, the transceiver 825 communicates with one or more cells (or wireless coverage areas) supported by one or more base units 121. In various embodiments, the transceiver 825 is operable on unlicensed spectrum. Moreover, the transceiver 825 may include multiple UE panels supporting one or more beams. Additionally, the transceiver 825 may support at least one network interface 840 and/or application interface 845. The application interface(s) 845 may support one or more APIs. The network interface(s) 840 may support 3GPP reference points, such as Uu, N1, PC5, etc. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825.

In various embodiments, the processor 805 controls the user equipment apparatus 800 to implement the above-described UE behaviors. In certain embodiments, the processor 805 may include an application processor (also known as “main processor”) which manages application-domain and operating system (“OS”) functions and a baseband processor (also known as “baseband radio processor”) which manages radio functions.

In various embodiments, via the transceiver 825, the processor 805 receives a DL transmission (e.g., PDSCH) in an SPS resource (or PDSCH occasion) of a plurality of SPS resources (or plurality of PDSCH occasions) within an SPS period corresponding to an SPS configuration of a plurality of SPS configurations. The processor 805 generates a HARQ feedback corresponding to the received DL transmission.

The processor 805 determines an SPS reference corresponding to the DL transmission, the SPS reference including a reference SPS configuration of the plurality of SPS configurations, a reference SPS resource of the plurality of SPS resources, or a combination thereof. Via the transceiver 825, the processor 805 transmits the HARQ feedback in an UL resource corresponding to the determined SPS reference, the reference SPS resource being different than the SPS resource.

Note that note that the SPS resource is a DL resource, but it can have an associated UL resource for HARQ-ACK transmission in response to a DL transmission in the SPS resource. The associated UL resource is usually determined based on a DCI activating the SPS configuration. In certain embodiments, there is no DL transmission in an SPS resource of the reference SPS configuration; however, the UL resource associated with the reference SPS configuration may still be used to transmit HARQ-ACK of another SPS resource corresponding to another SPS configuration.

In some embodiments, to determine the UL resource, the processor 805 determines the UL resource based on a DCI activating the reference SPS configuration, and a respective SPS resource associated with the reference SPS configuration. In some embodiments, to receive the DL transmission, the processor 805 controls the transceiver 825 to receive a PDSCH transmission exclusively on a single SPS resource of the plurality of SPS resources.

In some embodiments, the processor 805 determines a HARQ process ID for the DL transmission based on the SPS reference (i.e., the reference SPS configuration and/or the reference SPS resource). In some embodiments, the plurality of SPS configurations corresponds to a plurality of SPS occasions in the SPS period, where the reference SPS configuration corresponds to a respective SPS occasion that ends the latest amongst the plurality of SPS occasions.

In some embodiments, a set of the plurality of SPS configurations start at a same time in the SPS period, where the DL transmission is associated with a DMRS. In such embodiments, the processor 805 determines to which SPS configuration of the set of SPS configurations the SPS resource belongs based on the DMRS. In certain embodiments, the each SPS configuration of the set of SPS configurations is associated with different DMRS sequences (e.g., different DMRS scrambling initialization and/or DMRS scrambling ID).

In some embodiments, a first portion of the DL transmission is received in a first SPS occasion. In such embodiments, the processor 805 determines if a second part of the DL transmission is present in a second SPS occasion. In response to determining that the second part is present in the second SPS occasion, the processor 805 receives (e.g., via the transceiver 825) the second part and decodes the DL transmission in response to receiving the second part. In certain embodiments, the processor 805 receives (e.g., via the transceiver 825) an indication in the first SPS occasion indicating whether the second part is present in the second SPS occasion.

In some embodiments, SPS resources (or SPS occasions) of a set of the SPS configurations share a common DMRS symbol (or time unit). In some embodiments, the SPS resource associated with the DL transmission includes a first plurality of SPS resources within the SPS period. In some embodiments, the plurality of SPS resources includes a first SPS resource from a first SPS configuration and a second SPS resource from a second SPS configuration, where the first SPS configuration and the second SPS configuration are different SPS configurations.

In various embodiments, the processor 805 determine a set of CG TOs (or PUSCH allocations or PUSCH occasions) from a plurality of CG TOs (or plurality of PUSCH allocations or plurality of PUSCH occasions) within a CG period of a CG configuration for transmission of an UL TB and selects an UL resource from a plurality of UL resources, where the selection is based on the determined set of CG TOs. Via the transceiver 825, the processor 805 transmits an indication of the determined set of CG TOs to a mobile communication network, using the selected UL resource, and transmits a respective UL TB on an UL channel (i.e., PUSCH) in the determined set of CG TOs.

In some embodiments, to determine the set of CG TOs, the processor 805 determines based on at least one of an UL TB size and an arrival time associated with the UL TB. In some embodiments, the CG configuration includes a set of CG configurations with a same CG configuration periodicity. In such embodiments, the indication may be sent prior to the end of the earliest ending CG configuration of the set of CG configurations.

In some embodiments, the UL resource is one of a PUCCH resource or a PUSCH. In some embodiments, to transmit the respective UL TB on the UL channel, the processor 805 controls the transceiver 825 to transmit exclusively on a single CG TO of the plurality of CG TOs (i.e., the set of CG TOs has only one CG TO). In some embodiments, the indication is sent via CG-UCI. In some embodiments, the indication is sent via a SR, where the SR is associated with a SR configuration corresponding to the CG configuration.

In some embodiments, to transmit the respective UL TB, the processor 805 controls the transceiver 825 to transmit using a first subset of the set of CG TOs. In such embodiments, the indication may further indicate whether another UL TB is to be transmitted in a remaining subset of the set of CG TOs.

The memory 810, in one embodiment, is a computer readable storage medium. In some embodiments, the memory 810 includes volatile computer storage media. For example, the memory 810 may include a RAM, including dynamic RAM (“DRAM”), synchronous dynamic RAM (“SDRAM”), and/or static RAM (“SRAM”). In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data related to transmissions without corresponding grants. For example, the memory 810 may store various parameters, panel/beam configurations, resource assignments, policies, and the like as described above. In certain embodiments, the memory 810 also stores program code and related data, such as an operating system or other controller algorithms operating on the user equipment apparatus 800.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, is designed to output visual, audible, and/or haptic signals. In some embodiments, the output device 820 includes an electronically controllable display or display device capable of outputting visual data to a user. For example, the output device 820 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 820 may include a wearable display separate from, but communicatively coupled to, the rest of the user equipment apparatus 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, the output device 820 may be located near the input device 815.

The transceiver 825 communicates with one or more network functions of a mobile communication network via one or more access networks. The transceiver 825 operates under the control of the processor 805 to transmit messages, data, and other signals and also to receive messages, data, and other signals. For example, the processor 805 may selectively activate the transceiver 825 (or portions thereof) at particular times in order to send and receive messages.

The transceiver 825 includes at least transmitter 830 and at least one receiver 835. One or more transmitters 830 may be used to provide UL communication signals to a base unit 121, such as the UL transmissions described herein. Similarly, one or more receivers 835 may be used to receive DL communication signals from the base unit 121, as described herein. Although only one transmitter 830 and one receiver 835 are illustrated, the user equipment apparatus 800 may have any suitable number of transmitters 830 and receivers 835. Further, the transmitter(s) 830 and the receiver(s) 835 may be any suitable type of transmitters and receivers. In one embodiment, the transceiver 825 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example, a single chip performing functions for use with both licensed and unlicensed radio spectrum. In some embodiments, the first transmitter/receiver pair and the second transmitter/receiver pair may share one or more hardware components. For example, certain transceivers 825, transmitters 830, and receivers 835 may be implemented as physically separate components that access a shared hardware resource and/or software resource, such as for example, the network interface 840.

In various embodiments, one or more transmitters 830 and/or one or more receivers 835 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 830 and/or one or more receivers 835 may be implemented and/or integrated into a multi-chip module. In some embodiments, other components such as the network interface 840 or other hardware components/circuits may be integrated with any number of transmitters 830 and/or receivers 835 into a single chip. In such embodiment, the transmitters 830 and receivers 835 may be logically configured as a transceiver 825 that uses one more common control signals or as modular transmitters 830 and receivers 835 implemented in the same hardware chip or in a multi-chip module.

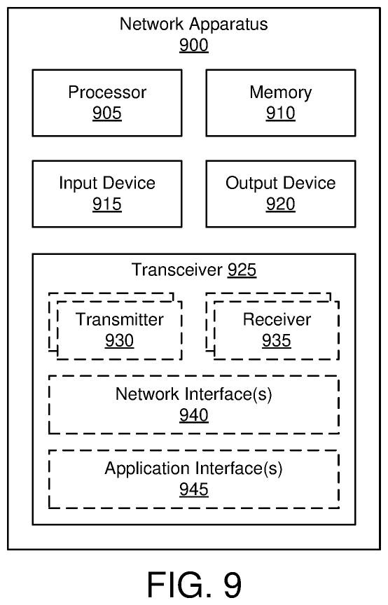

FIG. 9 depicts a network apparatus 900 that may be used for transmissions without corresponding grants, according to embodiments of the disclosure. In one embodiment, network apparatus 900 may be one implementation of a network endpoint, such as the base unit 121 and/or RAN node 207, as described above. Furthermore, the network apparatus 900 may include a processor 905, a memory 910, an input device 915, an output device 920, and a transceiver 925.

In some embodiments, the input device 915 and the output device 920 are combined into a single device, such as a touchscreen. In certain embodiments, the network apparatus 900 may not include any input device 915 and/or output device 920. In various embodiments, the network apparatus 900 may include one or more of: the processor 905, the memory 910, and the transceiver 925, and may not include the input device 915 and/or the output device 920.

As depicted, the transceiver 925 includes at least one transmitter 930 and at least one receiver 935. Here, the transceiver 925 communicates with one or more remote units 105. Additionally, the transceiver 925 may support at least one network interface 940 and/or application interface 945. The application interface(s) 945 may support one or more APIs. The network interface(s) 940 may support 3GPP reference points, such as Uu, N1, N2 and N3. Other network interfaces 940 may be supported, as understood by one of ordinary skill in the art.

The processor 905, in one embodiment, may include any known controller capable of executing computer-readable instructions and/or capable of performing logical operations. For example, the processor 905 may be a microcontroller, a microprocessor, a CPU, a GPU, an auxiliary processing unit, a FPGA, or similar programmable controller. In some embodiments, the processor 905 executes instructions stored in the memory 910 to perform the methods and routines described herein. The processor 905 is communicatively coupled to the memory 910, the input device 915, the output device 920, and the transceiver 925.

In various embodiments, the network apparatus 900 is a RAN node (e.g., gNB) that communicates with one or more UEs, as described herein. In such embodiments, the processor 905 controls the network apparatus 900 to perform the above-described RAN behaviors. When operating as a RAN node, the processor 905 may include an application processor (also known as “main processor”) which manages application-domain and operating system (“OS”) functions and a baseband processor (also known as “baseband radio processor”) which manages radio functions.

In various embodiments the processor 905 determines an SPS resource of a plurality of SPS resources within an SPS period corresponding to an SPS configuration of a plurality of SPS configurations and, via the transceiver 925, transmits a DL transmission (i.e., a TB/PDSCH) in the determined SPS resource. The processor 905 determines an SPS reference corresponding to the DL transmission and, via the transceiver 925, receives HARQ feedback corresponding to the DL transmission in an UL resource corresponding to the SPS reference. Here, the SPS reference may comprise a reference SPS configuration of the plurality of SPS configurations, a reference SPS resource of the plurality of SPS resources, or a combination thereof, where the reference SPS resource is different than the SPS resource in which the DL transmission is made.

In some embodiments, to determine the SPS resource, the processor 905 determines a set of SPS occasions from among a first set of SPS occasions corresponding to a first set of SPS configurations and a second set of SPS occasions corresponding to a second set of SPS configurations, where the determined SPS resource belongs to the determined set of SPS occasions. In certain embodiments, the first set of SPS occasions is a subset of the second set of SPS occasions.

In some embodiments, to transmit the DL transmission, the processor 905 controls the transceiver 925 to transmit a PDSCH transmission exclusively on a single SPS resource of the plurality of SPS resources. In some embodiments, the processor 905 determines a HARQ process ID for the DL transmission based on the SPS reference (i.e., the reference SPS configuration and/or the reference SPS resource).

In some embodiments, a set of the plurality of SPS configurations starts at a same time in the SPS period, where the DL transmission is associated with a DMRS. In such embodiments, the processor 905 determines to which SPS configuration of the set of SPS configurations the SPS resource belongs based on the DMRS. In certain embodiments, the each SPS configuration of the set of SPS configurations is associated with different DMRS sequences (e.g., different DMRS scrambling initialization and/or DMRS scrambling ID).

In some embodiments, the plurality of SPS configurations corresponds to a plurality of SPS occasions in the SPS period, where the reference SPS configuration corresponds to a respective SPS occasion that ends the latest amongst the plurality of SPS occasions. In some embodiments, a first portion of the DL transmission is received in a first SPS occasion. In such embodiments, where the processor 905 controls the transceiver 925 to: A) transmit a second part of the DL transmission in a second SPS occasion; and B) transmit an indication in the first SPS occasion indicating whether the second part is present in the second SPS occasion.

In some embodiments, SPS resources (or SPS occasions) of a set of the SPS configurations share a common DMRS symbol (or time unit). In some embodiments, the SPS resource associated with the DL transmission includes a first plurality of SPS resources within the SPS period. In some embodiments, the plurality of SPS resources includes a first SPS resource from a first SPS configuration and a second SPS resource from a second SPS configuration, where the first SPS configuration and the second SPS configuration are different SPS configurations.

In various embodiments, via the transceiver 925, the processor 905 transmits a CG configuration to a UE. The processor 905 controls the transceiver 925 to receive, from the UE, an indication indicating a first set of CG TOs within a period of a CG configuration and to receive, from the UE, a first UL transmission (i.e., a UL TB) on an UL channel during the indicated first set of CG TOs. The processor 905 schedules a second UL transmission in a second set of CG TOs within the period of the CG configuration, where the first set and the second set of CG TOs are mutually exclusive.

In some embodiments, the second set of TOs include TOs after the first set of TOs. In some embodiments, the indication is received via CG-UCI. In some embodiments, the indication is sent via a SR, where the SR is associated with a SR configuration corresponding to the CG configuration.

In some embodiments, the CG configuration includes a set of CG configurations with the same CG configuration periodicity. In such embodiments, the indication may further indicate a subset of the set of CG configurations, where the network may schedule the UL transmission in the TOs of the subset of the CG configurations.

In some embodiments, the CG configuration includes a set of CG configurations with a same CG configuration periodicity. In such embodiments, the indication may be received prior to the end of the earliest ending CG configuration of the set of CG configurations.

In some embodiments, the first UL transmission is received on one of a PUCCH resource or a PUSCH. In some embodiments, to receive the first UL transmission on the UL channel, the processor 905 controls the transceiver 925 to receive exclusively on a single CG TO of the plurality of CG TOs (i.e., the set of CG TOs has only one CG TO).

The memory 910, in one embodiment, is a computer readable storage medium. In some embodiments, the memory 910 includes volatile computer storage media. For example, the memory 910 may include a RAM, including DRAM, SDRAM, and/or SRAM. In some embodiments, the memory 910 includes non-volatile computer storage media. For example, the memory 910 may include a hard disk drive, a flash memory, or any other suitable non-volatile computer storage device. In some embodiments, the memory 910 includes both volatile and non-volatile computer storage media.

In some embodiments, the memory 910 stores data related to transmissions without corresponding grants. For example, the memory 910 may store parameters, configurations, resource assignments, policies, and the like, as described above. In certain embodiments, the memory 910 also stores program code and related data, such as an operating system or other controller algorithms operating on the network apparatus 900.

The input device 915, in one embodiment, may include any known computer input device including a touch panel, a button, a keyboard, a stylus, a microphone, or the like. In some embodiments, the input device 915 may be integrated with the output device 920, for example, as a touchscreen or similar touch-sensitive display. In some embodiments, the input device 915 includes a touchscreen such that text may be input using a virtual keyboard displayed on the touchscreen and/or by handwriting on the touchscreen. In some embodiments, the input device 915 includes two or more different devices, such as a keyboard and a touch panel.

The output device 920, in one embodiment, is designed to output visual, audible, and/or haptic signals. In some embodiments, the output device 920 includes an electronically controllable display or display device capable of outputting visual data to a user. For example, the output device 920 may include, but is not limited to, an LCD display, an LED display, an OLED display, a projector, or similar display device capable of outputting images, text, or the like to a user. As another, non-limiting, example, the output device 920 may include a wearable display separate from, but communicatively coupled to, the rest of the network apparatus 900, such as a smart watch, smart glasses, a heads-up display, or the like. Further, the output device 920 may be a component of a smart phone, a personal digital assistant, a television, a table computer, a notebook (laptop) computer, a personal computer, a vehicle dashboard, or the like.

In certain embodiments, the output device 920 includes one or more speakers for producing sound. For example, the output device 920 may produce an audible alert or notification (e.g., a beep or chime). In some embodiments, the output device 920 includes one or more haptic devices for producing vibrations, motion, or other haptic feedback. In some embodiments, all or portions of the output device 920 may be integrated with the input device 915. For example, the input device 915 and output device 920 may form a touchscreen or similar touch-sensitive display. In other embodiments, the output device 920 may be located near the input device 915.

The transceiver 925 includes at least transmitter 930 and at least one receiver 935. One or more transmitters 930 may be used to communicate with the UE, as described herein. Similarly, one or more receivers 935 may be used to communicate with network functions in the PLMN and/or RAN, as described herein. Although only one transmitter 930 and one receiver 935 are illustrated, the network apparatus 900 may have any suitable number of transmitters 930 and receivers 935. Further, the transmitter(s) 930 and the receiver(s) 935 may be any suitable type of transmitters and receivers.

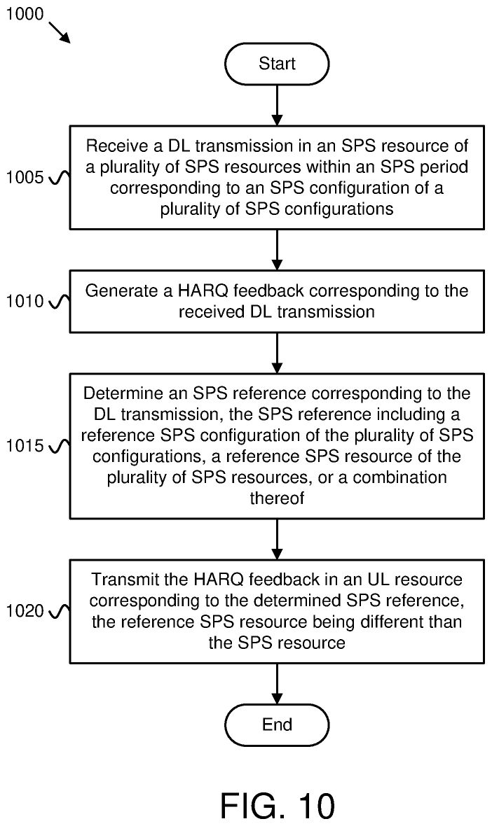

FIG. 10 depicts one embodiment of a method 1000 for transmissions without corresponding grants, according to embodiments of the disclosure. In various embodiments, the method 1000 is performed by a communication device, such as a remote unit 105, a UE 205, and/or the user equipment apparatus 800, described above, as described above. In some embodiments, the method 1000 is performed by a processor, such as a microcontroller, a microprocessor, a CPU, a GPU, an auxiliary processing unit, a FPGA, or the like.

The method 1000 includes receiving 1005 a DL transmission (e.g., TB/PDSCH) in an SPS resource of a plurality of SPS resources within an SPS period corresponding to an SPS configuration of a plurality of SPS configurations. The method 1000 includes generating 1010 a HARQ feedback corresponding to the received DL transmission. The method 1000 includes determining 1015 an SPS reference corresponding to the DL transmission, the SPS reference including a reference SPS configuration of the plurality of SPS configurations, a reference SPS resource of the plurality of SPS resources, or a combination thereof. The method 1000 includes transmitting 1020 the HARQ feedback in an UL resource corresponding to the determined SPS reference, the reference SPS resource being different than the SPS resource. The method 1000 ends.

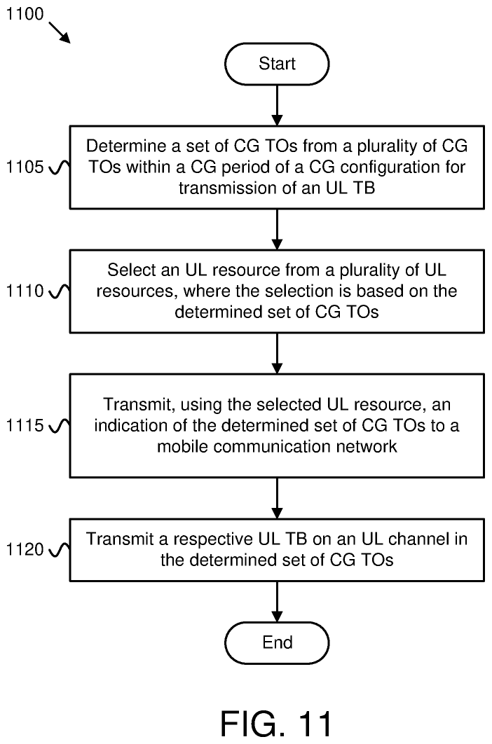

FIG. 11 depicts one embodiment of a method 1100 for transmissions without corresponding grants, according to embodiments of the disclosure. In various embodiments, the method 1100 is performed by a communication device, such as a remote unit 105, a UE 205, and/or the user equipment apparatus 800, described above. In some embodiments, the method 1100 is performed by a processor, such as a microcontroller, a microprocessor, a CPU, a GPU, an auxiliary processing unit, a FPGA, or the like.

The method 1100 includes determining 1105 a set of CG TOs from a plurality of CG TOs within a CG period of a CG configuration for transmission of an UL TB. The method 1100 includes selecting 1110 an UL resource from a plurality of UL resources, where the selection is based on the determined set of CG TOs. The method 1100 includes transmitting 1115, using the selected UL resource, an indication of the determined set of CG TOs to a mobile communication network. The method 1100 includes transmitting 1120 a respective UL TB on an UL channel (e.g., PUSCH) in the determined set of CG TOs. The method 1100 ends.

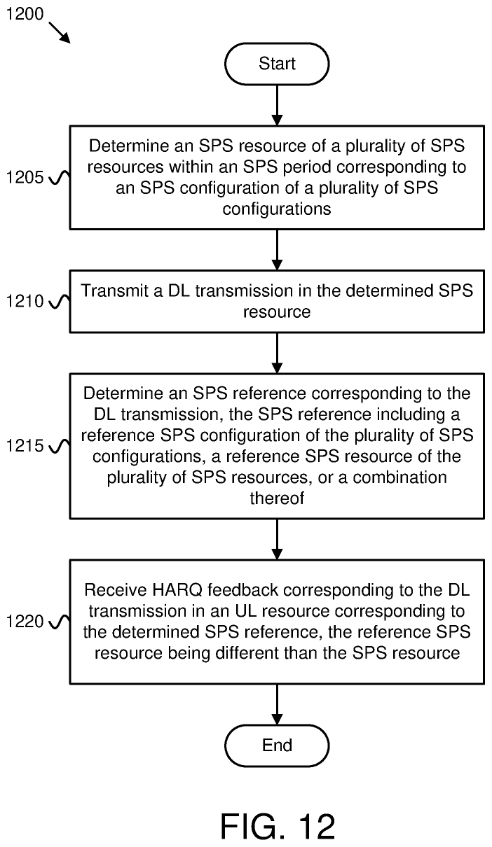

FIG. 12 depicts one embodiment of a method 1200 for transmissions without corresponding grants, according to embodiments of the disclosure. In various embodiments, the method 1200 is performed by a network device, such as the base unit 121, the RAN node 210, and/or the network apparatus 900, as described above. In some embodiments, the method 1200 is performed by a processor, such as a microcontroller, a microprocessor, a CPU, a GPU, an auxiliary processing unit, a FPGA, or the like.

The method 1200 includes determining 1205 an SPS resource of a plurality of SPS resources within an SPS period corresponding to an SPS configuration of a plurality of SPS configurations. The method 1200 includes transmitting 1210 a DL transmission (i.e., a TB/PDSCH) in the determined SPS resource. The method 1200 includes determining 1215 an SPS reference corresponding to the TB, the SPS reference including a reference SPS configuration of the plurality of SPS configurations, a reference SPS resource of the plurality of SPS resources, or a combination thereof. The method 1200 includes receiving 1220 HARQ feedback corresponding to the DL transmission in an UL resource corresponding to the determined SPS reference, the reference SPS resource being different than the SPS resource. The method 1200 ends.

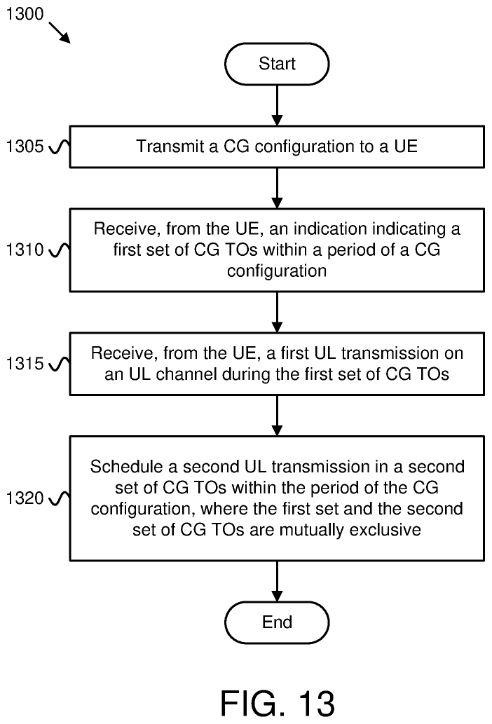

FIG. 13 depicts one embodiment of a method 1300 for transmissions without corresponding grants, according to embodiments of the disclosure. In various embodiments, the method 1300 is performed by a network device, such as the base unit 121, the RAN node 210, and/or the network apparatus 900, as described above. In some embodiments, the method 1300 is performed by a processor, such as a microcontroller, a microprocessor, a CPU, a GPU, an auxiliary processing unit, a FPGA, or the like.

The method 1300 includes transmitting 1305 a CG configuration to a UE. The method 1300 includes receiving 1310, from the UE, an indication indicating a first set of CG TOs within a period of a CG configuration. The method 1300 includes receiving 1315, from the UE, a first UL transmission (i.e., UL TB) on an UL channel during the first set of CG TOs. The method 1300 includes scheduling 1320 a second UL transmission in a second set of CG TOs within the period of the CG configuration, where the first set and the second set of CG TOs are mutually exclusive. The method 1300 ends.

Disclosed herein is a first apparatus for transmissions without corresponding grants, according to embodiments of the disclosure. The first apparatus may be implemented by a communication device, such as a remote unit 105, a UE 205, and/or the user equipment apparatus 800, described above. The first apparatus includes a processor coupled to a transceiver, the transceiver configured to communicate with a mobile communication network and the processor configured to cause the apparatus to: A) receive a DL transmission (e.g., PDSCH) in an SPS resource of a plurality of SPS resources within an SPS period corresponding to an SPS configuration of a plurality of SPS configurations; B) generate a HARQ feedback corresponding to the received DL transmission; C) determine an SPS reference corresponding to the DL transmission, the SPS reference including a reference SPS configuration of the plurality of SPS configurations, a reference SPS resource of the plurality of SPS resources, or a combination thereof; and D) transmit the HARQ feedback in an UL resource corresponding to the determined SPS reference, the reference SPS resource being different than the SPS resource.

In some embodiments, to determine the UL resource, the processor is configured to cause the apparatus to determine the UL resource based on a DCI activating the reference SPS configuration, and a respective SPS resource associated with the reference SPS configuration. In some embodiments, to receive the DL transmission, the processor is configured to cause the apparatus to receive a PDSCH exclusively on a single SPS resource of the plurality of SPS resources.

In some embodiments, the processor is further configured to cause the apparatus to determine a HARQ process ID for the DL transmission based on the SPS reference (i.e., the reference SPS configuration and/or the reference SPS resource). In some embodiments, the plurality of SPS configurations corresponds to a plurality of SPS occasions in the SPS period, where the reference SPS configuration corresponds to a respective SPS occasion that ends the latest amongst the plurality of SPS occasions.

In some embodiments, a set of the plurality of SPS configurations start at a same time in the SPS period, where the DL transmission is associated with a DMRS. In such embodiments, the processor may be further configured to cause the apparatus to determine to which SPS configuration of the set of SPS configurations the SPS resource belongs based on the DMRS. In certain embodiments, the each SPS configuration of the set of SPS configurations is associated with different DMRS sequences (e.g., different DMRS scrambling initialization and/or DMRS scrambling ID).

In some embodiments, a first portion of the DL transmission is received in a first SPS occasion. In such embodiments, the processor may be further configured to cause the apparatus to: A) determine if a second part of the DL transmission is present in a second SPS occasion; B) receive the second part in response to determining that the second part is present in the second SPS occasion; and C) decode the DL transmission in response to receiving the second part. In certain embodiments, the processor is further configured to cause the apparatus to receive an indication in the first SPS occasion indicating whether the second part is present in the second SPS occasion.

In some embodiments, SPS resources (or SPS occasions) of a set of the SPS configurations share a common DMRS symbol (or time unit). In some embodiments, the SPS resource associated with the DL transmission includes a first plurality of SPS resources within the SPS period. In some embodiments, the plurality of SPS resources includes a first SPS resource from a first SPS configuration and a second SPS resource from a second SPS configuration, where the first SPS configuration and the second SPS configuration are different SPS configurations.

Disclosed herein is a first method for transmissions without corresponding grants, according to embodiments of the disclosure. The first method may be performed by a communication device, such as a remote unit 105, a UE 205, and/or the user equipment apparatus 800, described above. The first method includes receiving a DL transmission (e.g., TB/PDSCH) in an SPS resource of a plurality of SPS resources within an SPS period corresponding to an SPS configuration of a plurality of SPS configurations and generating a HARQ feedback corresponding to the received DL transmission. The first method includes determining an SPS reference corresponding to the DL transmission, the SPS reference including a reference SPS configuration of the plurality of SPS configurations, a reference SPS resource of the plurality of SPS resources, or a combination thereof. The first method includes transmitting the HARQ feedback in an UL resource corresponding to the determined SPS reference, the reference SPS resource being different than the SPS resource.

In some embodiments, determining the UL resource includes determining the UL resource based on a DCI activating the reference SPS configuration, and a respective SPS resource associated with the reference SPS configuration. In some embodiments, receiving the DL transmission includes receiving a PDSCH exclusively on a single SPS resource of the plurality of SPS resources.

In some embodiments, the first method further includes determining a HARQ process ID for the DL transmission based on the SPS reference (i.e., the reference SPS configuration and/or the reference SPS resource). In some embodiments, the plurality of SPS configurations corresponds to a plurality of SPS occasions in the SPS period, where the reference SPS configuration corresponds to a respective SPS occasion that ends the latest amongst the plurality of SPS occasions.

In some embodiments, a set of the plurality of SPS configurations start at a same time in the SPS period, where the DL transmission is associated with a DMRS. In such embodiments, the first method may further include determining to which SPS configuration of the set of SPS configurations the SPS resource belongs based on the DMRS. In certain embodiments, the each SPS configuration of the set of SPS configurations is associated with different DMRS sequences (e.g., different DMRS scrambling initialization and/or DMRS scrambling ID).

In some embodiments, a first portion of the DL transmission is received in a first SPS occasion. In such embodiments, the first method may further include determining if a second part of the DL transmission is present in a second SPS occasion and receiving the second part in response to determining that the second part is present in the second SPS occasion. Here, the first method also includes decoding the DL transmission in response to receiving the second part. In certain embodiments, the first method further includes receiving an indication in the first SPS occasion indicating whether the second part is present in the second SPS occasion.

In some embodiments, SPS resources (or SPS occasions) of a set of the SPS configurations share a common DMRS symbol (or time unit). In some embodiments, the SPS resource associated with the DL transmission includes a first plurality of SPS resources within the SPS period. In some embodiments, the plurality of SPS resources includes a first SPS resource from a first SPS configuration and a second SPS resource from a second SPS configuration, where the first SPS configuration and the second SPS configuration are different SPS configurations.

Disclosed herein is a second apparatus for transmissions without corresponding grants, according to embodiments of the disclosure. The second apparatus may be implemented by a communication device, such as a remote unit 105, a UE 205, and/or the user equipment apparatus 800, described above. The second apparatus includes a processor coupled to a transceiver, the transceiver configured to communicate with a mobile communication network and the processor configured to cause the apparatus to: A) determine a set of CG TOs from a plurality of CG TOs within a CG period of a CG configuration for transmission of an UL TB; B) select an UL resource from a plurality of UL resources, where the selection is based on the determined set of CG TOs; C) transmit, using the selected UL resource, an indication of the determined set of CG TOs to a mobile communication network; and D) transmit a respective UL TB on an UL channel (i.e., PUSCH) in the determined set of CG TOs.

In some embodiments, to determine the set of CG TOs, the processor is configured to cause the apparatus to determine based on at least one of an UL TB size and an arrival time associated with the UL TB. In some embodiments, the CG configuration includes a set of CG configurations with a same CG configuration periodicity. In such embodiments, the indication may be sent prior to the end of the earliest ending CG configuration of the set of CG configurations.

In some embodiments, the UL resource is one of a PUCCH resource or a PUSCH. In some embodiments, to transmit the respective UL TB on the UL channel, the processor is configured to cause the apparatus to transmit exclusively on a single CG TO of the plurality of CG TOs (i.e., the set of CG TOs has only one CG TO). In some embodiments, the indication is sent via CG-UCI. In some embodiments, the indication is sent via a SR, where the SR is associated with a SR configuration corresponding to the CG configuration.

In some embodiments, to transmit the respective UL TB, the processor is configured to cause the apparatus to transmit using a first subset of the set of CG TOs. In such embodiments, the indication may further indicate whether another UL TB is to be transmitted in a remaining subset of the set of CG TOs.

Disclosed herein is a second method for transmissions without corresponding grants, according to embodiments of the disclosure. The second method may be performed by a communication device, such as a remote unit 105, a UE 205, and/or the user equipment apparatus 800, described above, described above. The second method includes determining a set of CG TOs from a plurality of CG TOs within a CG period of a CG configuration for transmission of an UL TB and selecting an UL resource from a plurality of UL resources, where the selection is based on the determined set of CG TOs. The second method includes transmitting, using the selected UL resource, an indication of the determined set of CG TOs to a mobile communication network and transmitting a respective UL TB on an UL channel (e.g., PUSCH) in the determined set of CG TOs.

In some embodiments, determining the set of CG TOs includes determining based on at least one of an UL TB size and an arrival time associated with the UL TB. In some embodiments, the CG configuration includes a set of CG configurations with a same CG configuration periodicity, where the indication is sent prior to the end of the earliest ending CG configuration of the set of CG configurations.

In some embodiments, the UL resource is one of a PUCCH resource or a PUSCH. In such embodiments, transmitting the respective UL TB on the UL channel includes transmitting exclusively on a single CG TO of the plurality of CG TOs (i.e., the set of CG TOs has only one CG TO). In some embodiments, the indication is sent via CG-UCI. In some embodiments, the indication is sent via a SR, where the SR is associated with a SR configuration corresponding to the CG configuration.

In some embodiments, transmitting the respective UL TB uses a first subset of the set of CG TOs. In such embodiments, the indication may further indicate whether another UL TB is to be transmitted in a remaining subset of the set of CG TOs.

Disclosed herein is a third apparatus for transmissions without corresponding grants, according to embodiments of the disclosure. The third apparatus may be implemented by a network device, such as the base unit 121, the RAN node 210, and/or the network apparatus 900, as described above. The third apparatus includes a processor coupled to a transceiver, the transceiver configured to communicate with a UE and the processor configured to cause the apparatus to: A) determine an SPS resource of a plurality of SPS resources within an SPS period corresponding to an SPS configuration of a plurality of SPS configurations; B) transmit a DL transmission (i.e., a TB/PDSCH) in the determined SPS resource; C) determine an SPS reference corresponding to the DL transmission, the SPS reference including a reference SPS configuration of the plurality of SPS configurations, a reference SPS resource of the plurality of SPS resources, or a combination thereof; and D) receive HARQ feedback corresponding to the DL transmission in an UL resource corresponding to the determined SPS reference, the reference SPS resource being different than the SPS resource.

In some embodiments, to determine the SPS resource, the processor further determines a set of SPS occasions from among a first set of SPS occasions corresponding to a first set of SPS configurations and a second set of SPS occasions corresponding to a second set of SPS configurations, where the determined SPS resource belongs to the determined set of SPS occasions. In certain embodiments, the first set of SPS occasions is a subset of the second set of SPS occasions.

In some embodiments, to transmit the DL transmission, the processor is configured to cause the apparatus to transmit a PDSCH transmission exclusively on a single SPS resource of the plurality of SPS resources. In some embodiments, the processor is further configured to cause the apparatus to determine a HARQ process ID for the DL transmission based on the SPS reference (i.e., the reference SPS configuration and/or the reference SPS resource).

In some embodiments, a set of the plurality of SPS configurations starts at a same time in the SPS period, where the DL transmission is associated with a DMRS. In such embodiments, the processor is further configured to cause the apparatus to determine to which SPS configuration of the set of SPS configurations the SPS resource belongs based on the DMRS. In certain embodiments, the each SPS configuration of the set of SPS configurations is associated with different DMRS sequences (e.g., different DMRS scrambling initialization and/or DMRS scrambling ID).

In some embodiments, the plurality of SPS configurations corresponds to a plurality of SPS occasions in the SPS period, where the reference SPS configuration corresponds to a respective SPS occasion that ends the latest amongst the plurality of SPS occasions. In some embodiments, a first portion of the DL transmission is received in a first SPS occasion. In such embodiments, where the processor is further configured to cause the apparatus to: A) transmit a second part of the DL transmission in a second SPS occasion; and B) transmit an indication in the first SPS occasion indicating whether the second part is present in the second SPS occasion.

In some embodiments, SPS resources (or SPS occasions) of a set of the SPS configurations share a common DMRS symbol (or time unit). In some embodiments, the SPS resource associated with the DL transmission includes a first plurality of SPS resources within the SPS period. In some embodiments, the plurality of SPS resources includes a first SPS resource from a first SPS configuration and a second SPS resource from a second SPS configuration, where the first SPS configuration and the second SPS configuration are different SPS configurations.

Disclosed herein is a third method for transmissions without corresponding grants, according to embodiments of the disclosure. The third method may be performed by a network device, such as the base unit 121, the RAN node 210, and/or the network apparatus 900, as described above. The third method includes determining an SPS resource of a plurality of SPS resources within an SPS period corresponding to an SPS configuration of a plurality of SPS configurations and transmitting a DL transmission (i.e., a TB/PDSCH) in the determined SPS resource. The third method includes determining an SPS reference corresponding to the TB, the SPS reference including a reference SPS configuration of the plurality of SPS configurations, a reference SPS resource of the plurality of SPS resources, or a combination thereof. The third method includes receiving HARQ feedback corresponding to the DL transmission in an UL resource corresponding to the determined SPS reference, the reference SPS resource being different than the SPS resource.

In some embodiments, determining the SPS resource includes determining a set of SPS occasions from among a first set of SPS occasions corresponding to a first set of SPS configurations and a second set of SPS occasions corresponding to a second set of SPS configurations, where the determined SPS resource belongs to the determined set of SPS occasions. In certain embodiments, the first set of SPS occasions is a subset of the second set of SPS occasions.

In some embodiments, transmitting the DL transmission includes transmitting a PDSCH exclusively on a single SPS resource of the plurality of SPS resources. In some embodiments, the third method further includes determining a HARQ process ID for the DL transmission based on the SPS reference (i.e., the reference SPS configuration and/or the reference SPS resource).

In some embodiments, a set of the plurality of SPS configurations starts at a same time in the SPS period, where the DL transmission is associated with a DMRS. In such embodiments, the third method further includes determining to which SPS configuration of the set of SPS configurations the SPS resource belongs based on the DMRS. In certain embodiments, the each SPS configuration of the set of SPS configurations is associated with different DMRS sequences (e.g., different DMRS scrambling initialization/ID).

In some embodiments, the plurality of SPS configurations corresponds to a plurality of SPS occasions in the SPS period, where the reference SPS configuration corresponds to a respective SPS occasion that ends the latest amongst the plurality of SPS occasions. In some embodiments, a first portion of the DL transmission is received in a first SPS occasion. In such embodiments, the third method may further include: transmitting a second part of the DL transmission in a second SPS occasion and transmitting an indication in the first SPS occasion indicating whether the second part is present in the second SPS occasion.

In some embodiments, SPS resources (or SPS occasions) of a set of the SPS configurations share a common DMRS symbol (or time unit). In some embodiments, the SPS resource associated with the DL transmission includes a first plurality of SPS resources within the SPS period. In some embodiments, the plurality of SPS resources includes a first SPS resource from a first SPS configuration and a second SPS resource from a second SPS configuration, and where the first SPS configuration and the second SPS configuration are different SPS configurations.

Disclosed herein is a fourth apparatus for transmissions without corresponding grants, according to embodiments of the disclosure. The fourth apparatus may be implemented by a network device, such as the base unit 121, the RAN node 210, and/or the network apparatus 900, as described above. The fourth apparatus includes a processor coupled to a transceiver, the transceiver configured to communicate with a UE and the processor configured to cause the apparatus to: A) transmit a CG configuration to a UE; B) receive, from the UE, an indication indicating a first set of CG TOs within a period of a CG configuration; C) receive, from the UE, a first UL transmission (i.e., a UL TB) on an UL channel during the first set of CG TOs; and D) schedule a second UL transmission in a second set of CG TOs within the period of the CG configuration, where the first set and the second set of CG TOs are mutually exclusive.

In some embodiments, the second set of TOs include TOs after the first set of TOs. In some embodiments, the indication is received via CG-UCI. In some embodiments, the indication is sent via a SR, where the SR is associated with a SR configuration corresponding to the CG configuration.

In some embodiments, the CG configuration includes a set of CG configurations with the same CG configuration periodicity. In such embodiments, the indication may further indicate a subset of the set of CG configurations, where the network may schedule the UL transmission in the TOs of the subset of the CG configurations.

In some embodiments, the CG configuration includes a set of CG configurations with a same CG configuration periodicity. In such embodiments, the indication may be received prior to the end of the earliest ending CG configuration of the set of CG configurations.

In some embodiments, the first UL transmission is received on one of a PUCCH resource or a PUSCH. In some embodiments, to receive the first UL transmission on the UL channel, the processor is configured to cause the apparatus to receive exclusively on a single CG TO of the plurality of CG TOs (i.e., the set of CG TOs has only one CG TO).

Disclosed herein is a fourth method for transmissions without corresponding grants, according to embodiments of the disclosure. The fourth method may be performed by a network device, such as the base unit 121, the RAN node 210, and/or the network apparatus 900, as described above. The fourth method includes transmitting a CG configuration to a UE and receiving, from the UE, an indication indicating a first set of CG TOs within a period of a CG configuration. The fourth method includes receiving, from the UE, a first UL transmission (i.e., UL TB) on an UL channel during the first set of CG TOs and scheduling a second UL transmission in a second set of CG TOs within the period of the CG configuration, where the first set and the second set of CG TOs are mutually exclusive.

In some embodiments, the second set of TOs include TOs after the first set of TOs. In some embodiments, the indication is received via CG-UCI. In some embodiments, the indication is sent via a SR, where the SR is associated with a SR configuration corresponding to the CG configuration.

In some embodiments, the CG configuration includes a set of CG configurations with the same CG configuration periodicity. In such embodiments, the indication may further indicate a subset of the set of CG configurations, where the network may schedule the UL transmission in the TOs of the subset of the CG configurations.

In some embodiments, the CG configuration includes a set of CG configurations with a same CG configuration periodicity. In such embodiments, the indication may be received prior to the end of the earliest ending CG configuration of the set of CG configurations.

In some embodiments, the first UL transmission is received on one of a PUCCH resource or a PUSCH. In some embodiments, receiving the first UL transmission on the UL channel comprises receiving exclusively on a single CG TO of the plurality of CG TOs (i.e., the set of CG TOs has only one CG TO).

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus comprising:
a transceiver; and
a processor coupled to the transceiver, the processor configured to cause the apparatus to:
receive a downlink (“DL”) transmission in a semi-persistently scheduled (“SPS”) resource of a plurality of SPS resources within an SPS period corresponding to an SPS configuration of a plurality of SPS configurations;
generate a Hybrid Automated Repeat Request (“HARQ”) feedback corresponding to the received DL transmission;
determine an SPS reference corresponding to the DL transmission, the SPS reference comprising a reference SPS configuration of the plurality of SPS configurations, a reference SPS resource of the plurality of SPS resources, or a combination thereof; and
transmit the HARQ feedback in an uplink (“UL”) resource corresponding to the determined SPS reference, the reference SPS resource being different than the SPS resource.

2. The apparatus of claim 1, wherein, to determine the UL resource, the processor is configured to cause the apparatus to determine the UL resource based on a Downlink Control Information (“DCI”) activating the reference SPS configuration, and a respective SPS resource associated with the reference SPS configuration.

3. The apparatus of claim 1, wherein, to receive the DL transmission, the processor is configured to cause the apparatus to receive a Physical Downlink Shared Channel (“PDSCH”) exclusively on a single SPS resource of the plurality of SPS resources.

4. The apparatus of claim 1, wherein the processor is further configured to cause the apparatus to determine a HARQ process identifier (“ID”) for the DL transmission based on the SPS reference.

5. The apparatus of claim 1, wherein the plurality of SPS configurations corresponds to a plurality of SPS occasions in the SPS period, wherein the reference SPS configuration corresponds to a respective SPS occasion that ends a latest amongst the plurality of SPS occasions.

6. The apparatus of claim 1, wherein a set of the plurality of SPS configurations start at a same time in the SPS period, wherein the DL transmission is associated with a demodulation reference signal (“DMRS”), and wherein the processor is further configured to cause the apparatus to determine to which SPS configuration of the set of SPS configurations the SPS resource belongs based on the DMRS.

7. The apparatus of claim 1, wherein a first portion of the DL transmission is received in a first SPS occasion, and wherein the processor is further configured to cause the apparatus to:
determine if a second part of the DL transmission is present in a second SPS occasion;
receive the second part in response to determining that the second part is present in the second SPS occasion; and
decode the DL transmission in response to receiving the second part.

8. The apparatus of claim 7, wherein the processor is further configured to cause the apparatus to receive an indication in the first SPS occasion indicating whether the second part is present in the second SPS occasion.

9. A method at a network node, the method comprising:
determining a semi-persistently scheduled (“SPS”) resource of a plurality of SPS resources within an SPS period corresponding to an SPS configuration of a plurality of SPS configurations;
transmitting a DL transmission in the determined SPS resource;
determining an SPS reference corresponding to the DL transmission, the SPS reference comprising a reference SPS configuration of the plurality of SPS configurations, a reference SPS resource of the plurality of SPS resources, or a combination thereof; and
receiving Hybrid Automatic Repeat Request (“HARQ”) feedback corresponding to the DL transmission in an uplink (“UL”) resource corresponding to the determined SPS reference, the reference SPS resource being different than the SPS resource.

10. An apparatus comprising:
a transceiver; and
a processor coupled to the transceiver, the processor configured to cause the apparatus to:
determine a set of configured grant (“CG”) transmission occasions (“TOs”) from a plurality of CG TOs within a CG period of a CG configuration for transmission of an uplink (“UL”) transport block (“TB”);
select an UL resource from a plurality of UL resources, wherein the selection is based on the determined set of CG TOs;
transmit, using the selected UL resource, an indication of the determined set of CG TOs to a mobile communication network; and
transmit a respective UL TB on an UL channel in the determined set of CG TOs.

11. The apparatus of claim 10, wherein the set of CG TOs is determined based on at least one of an UL TB size and an arrival time associated with the UL TB.

12. The apparatus of claim 10, wherein the CG configuration comprises a set of CG configurations with a same CG configuration periodicity, wherein the indication is sent prior to an end of the earliest ending CG configuration of the set of CG configurations.

13. The apparatus of claim 10, wherein the UL resource is one of a Physical Uplink Control Channel (“PUCCH”) resource or a Physical Uplink Shared Channel (“PUSCH”), wherein, to transmit the respective UL TB on the UL channel, the processor is configured to cause the apparatus to transmit exclusively on a single CG TO of the plurality of CG TOs.

14. The apparatus of claim 10, wherein the indication is sent via Configured Grant Uplink Control Information (“CG-UCI”) or a Scheduling Request (“SR”), wherein the SR is associated with a SR configuration corresponding to the CG configuration.

15. The apparatus of claim 10, wherein transmitting the respective UL TB uses a first subset of the set of CG TOs, wherein the indication further indicates whether another UL TB is to be transmitted in a remaining subset of the set of CG TOs.
